(19) United States
(12) Patent Application Publication
(10) Pub. No.: US 2022/0071208 A1
(43) Pub. Date: Mar. 10, 2022

(54) Pest Repellent Composition

(71) Applicant: Kao Corporation, Chuo-ku, Tokyo (JP)

(72) Inventors: Kouhei TAKEUCHI, Taito-ku, Tokyo (JP); Hiroyuki TAKIZAWA, Lumpini, Bangkok (TH)

(73) Assignee: Kao Corporation, Chuo-ku, Tokyo (JP)

(21) Appl. No.: 17/416,680

(22) PCT Filed: Dec. 19, 2019
(86) PCT No.: PCT/JP2019/049742

§ 371 Date: Jun. 21, 2021

(30) Foreign Application Priority Data
Dec. 28, 2018 (JP) 2018-248694

(51) Int. Cl. A01N 43/08; A01N 43/16; A01N 31/06; A01N 31/02; A01N 31/04; A01N 43/78; A01N 37/10

(52) U.S. Cl. CPC A01N 43/08; A01N 43/16; A01N 31/06; A01N 37/10; A01N 31/04; A01N 43/78; A01N 31/02

(57) ABSTRACT

The present invention relates to a pest repellent composition containing the following components (A) and (B):
(A) 13% by mass or more and 99.95% by mass or less of at least one non-volatile liquid oily component selected from the group consisting of a silicone oil, an ester oil, an ether oil, a hydrocarbon oil, an aliphatic alcohol, and a polyhydric alcohol, the non-volatile liquid oily component having a surface tension at 25° C. of 40 mN/m or less and a viscosity at 23° C. as measured with a B-type rotational viscometer of 400 mPa·s or less; and
(B) 0.05% by mass or more and 3.5% by mass or less of a prescribed fragrance.

### FIELD OF THE INVENTION

The present invention relates to a pest repellent composition.

### BACKGROUND OF THE INVENTION

Pests, for example, flying pests, such as mosquitoes and flies, carry pathogens to animals, such as humans and are factors that cause infectious diseases and dermatitis. In particular, some mosquitoes are hygienically very harmful insects because they carry pathogens, such as dengue fever, Zika fever, yellow fever, encephalitis, and malaria.

Conventionally, in order to protect themselves from such flying pests, a method of spraying an insecticide or applying a repellent onto the skin surface has been widely used. As a typical repellent, DEET (N,N-diethyl-toluamide) is commonly used.

Pests, such as mosquitoes, possess chemoreceptive systems, such as thermal receptors that sense the body temperature of animals, olfactory receptors that sense volatile substances, such as body odors, and carbon dioxide receptors that sense carbon dioxide, and detect the animals by them. However, DEET repels pests by modulating the chemoreceptive system of such pests and neutralizing the cognitive sensation of the pest.

However, DEET involves such problems that it has an unpleasant odor, and it is also required that a fixed amount or more of the compound is blended to exhibit a sufficient sustaining repellent effect. Furthermore, it is known that DEET causes allergy or chopped skin depending upon a human, and the use amount or the number of uses for infants and people with sensitive skin is limited.

Then, utilization of natural essential oils as a repellent component is studied. Natural essential oils, such as citronella oil, lemon eucalyptus oil, lemongrass oil, orange oil, and cassia oil, are also used for candles and aroma lotions and high in safety for a human body. However, their repellent effect against pests is not sufficient, and their practicality is problematic.

Besides, various proposals have been made for pest repellents and pest repellent compositions.

For example, PTL 1 describes that a skin protective agent having a fluorine-polyether co-modified silicone and a UV protective component blended therein is blended with an insect repellent, such as DEET.

In addition, use of a fragrance component as the repellent is also proposed. PTL 2 discloses an insect repellent which utilizes the fact that a fragrance component, such as octahydro-7-methyl-1,4-methanonaphthalen-6(2H)-one, acts on a thermal receptor of a blood-sucking insect to inhibit a thermal response. PTL 3 discloses that a fragrance component, such as 2-methoxy-4-propylphenol, inhibits a nerve response of an insect to a carbon dioxide stimulus and is used for repelling the insect.

### CITATION LIST

### Patent Literature

PTL 1: JP H8-59447 A

PTL 2: JP 2016-172715 A

PTL 3: JP 2016-164153 A

### SUMMARY OF THE INVENTION

The present invention provides the following [1] to [7].

[1] A pest repellent composition or pest stay inhibition composition containing the following components (A) and (B):

(A) 13% by mass or more and 99.95% by mass or less of at least one non-volatile liquid oily component selected from the group consisting of a silicone oil, an ester oil, an ether oil, a hydrocarbon oil, an aliphatic alcohol, and a polyhydric alcohol, the non-volatile liquid oily component having a surface tension at 25° C. of 40 mN/m or less and a viscosity at 23° C. as measured with a B-type rotational viscometer of 400 mPa·s or less; and

(B) 0.05% by mass or more and 3.5% by mass or less of at least one fragrance selected from the group consisting of the following (B1) to (B9):

(B1) at least one lactone selected from the group consisting of octahydro-2H-1-benzopyran-2-one, gamma decalactone, delta decalactone, delta nonalactone, and gamma undecalactone,

(B2) at least one ketone selected from the group consisting of 9-ethylidene-3-oxatricyclo[6.2.1.0^{2,7}]undecan-4-one and octahydro-7-methyl-1,4-methanonaphthalene-6(2H)-one,

(B3) at least one aldehyde selected from the group consisting of 7-hydroxy-3,7-dimethyloctanal and octahydro-5-methoxy-4,7-methano-1H-indene-2-carboxyaldehyde,

(B4) at least one aromatic alcohol selected from the group consisting of phenylethyl methyl ethyl carbinol, cinnamic alcohol, and eugenol,

(B5) 2-(4-methyl-2-thiazolyl) ethanol,

(B6) ethyl-2-phenyl acetate,

(B7) (3-pentyloxan-4-yl) acetate,

(B8) phenylethyl dimethyl carbinyl acetate, and

(B9) methyl anthranilate.

[2] An oil-in-water type mosquito repellent composition or mosquito stay inhibition composition containing the following components (A) to (C) and having the content of other pest repellent than the component (A) and the component (B) of 15% by mass or less:

(A) 13% by mass or more and 50% by mass or less of at least one non-volatile liquid oily component selected from the group consisting of a silicone oil, an ester oil, an ether oil, a hydrocarbon oil, an aliphatic alcohol, and a polyhydric alcohol, the non-volatile liquid oily component having a surface tension at 25° C. of 40 mN/m or less and a viscosity at 23° C. as measured with a B-type rotational viscometer of 400 mPa·s or less;

(B) 0.05% by mass or more and 3.5% by mass or less of at least one fragrance selected from the group consisting of the following (B1) to (B9):

(B1) at least one lactone selected from the group consisting of octahydro-2H-1-benzopyran-2-one, gamma decalactone, delta decalactone, delta nonalactone, and gamma undecalactone,

(B2) at least one ketone selected from the group consisting of 9-ethylidene-3-oxatricyclo[6.2.1.0^{2,7}]undecan-4-one and octahydro-7-methyl-1,4-methanonaphthalene-6(2H)-one,

(B3) at least one aldehyde selected from the group consisting of 7-hydroxy-3,7-dimethyloctanal and octahydro-5-methoxy-4,7-methano-1H-indene-2-carboxyaldehyde,

(B4) at least one aromatic alcohol selected from the group consisting of phenylethyl methyl ethyl carbinol, cinnamic alcohol, and eugenol,

(B5) 2-(4-methyl-2-thiazolyl) ethanol,

(B6) ethyl-2-phenyl acetate,

(B7) (3-pentyloxan-4-yl) acetate,

(B8) phenylethyl dimethyl carbinyl acetate, and

(B9) methyl anthranilate; and

(C) 35% by mass or more and 86.95% by mass or less of water.

[3] An oil-in-water type mosquito repellent composition or mosquito stay inhibition composition containing the following components (A) to (C), with a mass ratio [(A)/(B)] of the component (A) to the composition (B) being 10 or more and 400 or less, and having the content of other pest repellent than the component (A) and the component (B) of 15% by mass or less:

(A) 13% by mass or more and 50% by mass or less of at least one non-volatile liquid oily component selected from the group consisting of a silicone oil, an ester oil, an ether oil, a hydrocarbon oil, an aliphatic alcohol, and a polyhydric alcohol, the non-volatile liquid oily component having a surface tension at 25° C. of 40 mN/m or less and a viscosity at 23° C. as measured with a B-type rotational viscometer of 400 mPa·s or less;

(B) 0.05% by mass or more and 3.5% by mass or less of at least one fragrance selected from the group consisting of the following (B1) to (B9):

(B1) at least one lactone selected from the group consisting of octahydro-2H-1-benzopyran-2-one, gamma decalactone, delta decalactone, delta nonalactone, and gamma undecalactone,

(B2) at least one ketone selected from the group consisting of 9-ethylidene-3-oxatricyclo[6.2.1.0^{2,7}]undecan-4-one and octahydro-7-methyl-1,4-methanonaphthalene-6(2H)-one,

(B3) at least one aldehyde selected from the group consisting of 7-hydroxy-3,7-dimethyloctanal and octahydro-5-methoxy-4,7-methano-1H-indene-2-carboxyaldehyde,

(B4) at least one aromatic alcohol selected from the group consisting of phenylethyl methyl ethyl carbinol, cinnamic alcohol, and eugenol,

(B5) 2-(4-methyl-2-thiazolyl) ethanol,

(B6) ethyl-2-phenyl acetate,

(B7) (3-pentyloxan-4-yl) acetate,

(B8) phenylethyl dimethyl carbinyl acetate, and

(B9) methyl anthranilate; and

(C) 35% by mass or more and 86.95% by mass or less of water.

[4] An oil-in-water type mosquito repellent composition or mosquito stay inhibition composition containing the following components (A) to (C), with a mass ratio [(A)/(B)] of the component (A) to the composition (B) being 10 or more and 400 or less, and having the content of other pest repellent than the component (A) and the component (B) of 15% by mass or less:

(A) 13% by mass or more and 50% by mass or less of at least one non-volatile liquid oily component selected from the group consisting of a silicone oil, an ester oil, an ether oil, a hydrocarbon oil, an aliphatic alcohol, and a polyhydric alcohol, the non-volatile liquid oily component having a surface tension at 25° C. of 40 mN/m or less and a viscosity at 23° C. as measured with a B-type rotational viscometer of 400 mPa·s or less;

(B) 0.05% by mass or more and 3.5% by mass or less of at least one fragrance selected from octahydro-2H-1-benzopyran-2-one and 7-hydroxy-3,7-dimethyloctanal; and

(C) 35% by mass or more and 86.95% by mass or less of water.

[5] An oil-in-water type mosquito repellent composition or mosquito stay inhibition composition containing the following components (A) to (D), with a mass ratio [(A)/(B)] of the component (A) to the composition (B) being 10 or more and 400 or less, and having the content of other pest repellent than the component (A) and the component (B) of 15% by mass or less:

(A) 13% by mass or more and 50% by mass or less of at least one non-volatile liquid oily component selected from the group consisting of a silicone oil, an ester oil, and a hydrocarbon oil, the non-volatile liquid oily component having a surface tension at 25° C. of 40 mN/m or less and a viscosity at 23° C. as measured with a B-type rotational viscometer of 400 mPa·s or less;

(B) 0.05% by mass or more and 3.5% by mass or less of at least one fragrance selected from octahydro-2H-1-benzopyran-2-one and 7-hydroxy-3,7-dimethyloctanal;

(C) 35% by mass or more and 86.95% by mass or less of water; and

(D) 0.05% by mass or more and 3% by mass or less of a thickener.

[6] A method for repelling pests, including applying the composition as set forth in any one of the [1] to [5] onto the skin surface of a human.
[7] A method for inhibiting pest stay, including attaching the composition as set forth in any one of the [1] to [5] onto limbs of a pest to prevent the pest from staying on the skin of a human.

### DETAILED DESCRIPTION OF THE INVENTION

### [Pest Repellent Composition and Pest Stay Inhibition Composition]

The pest repellent composition and the pest stay inhibition composition of the present invention (these will be hereinafter also collectively referred to as “composition of the present invention”) are each a composition containing the following components (A) and (B):

(A) 13% by mass or more and 99.95% by mass or less of at least one non-volatile liquid oily component selected from the group consisting of a silicone oil, an ester oil, an ether oil, a hydrocarbon oil, an aliphatic alcohol, and a polyhydric alcohol, the non-volatile liquid oily component having a surface tension at 25° C. of 40 mN/m or less and a viscosity at 23° C. as measured with a B-type rotational viscometer of 400 mPa·s or less; and

(B) 0.05% by mass or more and 3.5% by mass or less of at least one fragrance selected from the group consisting of the following (B1) to (B9):

(B1) at least one lactone selected from the group consisting of octahydro-2H-1-benzopyran-2-one, gamma decalactone, delta decalactone, delta nonalactone, and gamma undecalactone,

(B2) at least one ketone selected from the group consisting of 9-ethylidene-3-oxatricyclo[6.2.1.0^{2,7}]undecan-4-one and octahydro-7-methyl-1,4-methanonaphthalene-6(2H)-one,

(B3) at least one aldehyde selected from the group consisting of 7-hydroxy-3,7-dimethyloctanal and octahydro-5-methoxy-4,7-methano-1H-indene-2-carboxyaldehyde,

(B4) at least one aromatic alcohol selected from the group consisting of phenylethyl methyl ethyl carbinol, cinnamic alcohol, and eugenol,

(B5) 2-(4-methyl-2-thiazolyl) ethanol,

(B6) ethyl-2-phenyl acetate,

(B7) (3-pentyloxan-4-yl) acetate,

(B8) phenylethyl dimethyl carbinyl acetate, and

(B9) methyl anthranilate.

The aforementioned (B1) to (B9) prescribed as the component (B) are each a compound which is known as a fragrance, and as one example, all of these compounds are disclosed as a fragrance in Motoichi INDO, “Gosei Koryo: Kagaku to Shohin Chisiki<Zoho Kaitei Ban> (Synthetic Fragrances: Chemistry and Knowledge of Products <Enlarged and Revised Edition>)”, published by The Chemical Daily Co., Ltd. in 2005 (ISBN4-87326-460-X).

The composition of the present invention is a pest repellent composition or a pest stay inhibition composition, each of which contains specified amounts of the component (A) and the component (B), is excellent in repellent sustaining effect against pests, particularly flying pests, is low in a strong odor derived from the fragrance having a repellent effect, and is suited for application to the skin. In the composition of the present invention, it may be considered that when a specified amount of the component (B) as mentioned later is contained in addition to the component (A), and the component (B) is applied to limbs of a flying pest together with the component (A), the excellent repellent sustaining effect could be realized while reducing the strong odor derived from the component (B).

Of the pest repellents, those to be applied to the skin are desired to be not only safe but also low in odor, and furthermore, excellent in not only initial repellent effect but also sustainability of the repellent effect. However, it is the present situation that currently usable major pest repellents do not thoroughly meet these desires.

As mentioned above, existing pest repellents, such as DEET as described in PTL 1, have an unpleasant odor and are problematic in safety for the human body, and therefore, there is demanded a repellent capable of being more safely used by infants and people with sensitive skin.

In the repellents using the compounds known as the fragrance component as described in PTLs 2 and 3, if the content of the fragrance component is increased, an improvement in the repellent sustaining effect is expected; whereas when the content of the fragrance component is high, skin troubles are caused, and a problem that the odor derived from the fragrance component is too strong to endure actual use is generated.

In the existing circumstances, a composition which is excellent in the pest repellent sustaining effect, is safe, is suppressed in the strong odor derived from the repellent component, and is suited for application to the skin has not been found yet.

A problem of the present invention is to provide a pest repellent composition which is excellent in the pest repellent sustaining effect against pests, particularly flying pests, is safe, is suppressed in the strong odor derived from a fragrance having a repellent effect, and is suited for application to the skin.

The present inventors made extensive and intensive investigations. As a result, it has been found that a non-volatile liquid oily component having specified surface tension and viscosity has an effect for repelling pests, such mosquitoes. Meanwhile, though it has been found that a specified fragrance has a repellent effect, too, in the case of contemplating to sustain the repellent effect, the strong odor was problematic. Then, it has been surprisingly found that when not only the content of the fragrance is controlled to the content in a degree such that the odor does not become problematic, but also the fragrance is combined with the non-volatile liquid oily component having specified surface tension and viscosity, the repellent sustaining effect is also prolonged while suppressing the strong odor derived from the fragrance. Namely, it has been found that the pest repellent composition containing specified amounts of the non-volatile liquid oily component having specified surface tension and viscosity and the specified fragrance component is able to solve the aforementioned problem.

In accordance with the present invention, it is possible to provide a pest repellent composition which is excellent in the pest repellent sustaining effect against pests, particularly flying pests, is safe, is suppressed in the strong odor derived from a fragrance having a repellent effect, and is suited for application to the skin, a pest stay inhibition composition, a method for repelling pests, and a method for inhibiting pest stay.

In the present invention, the term “repellent effect against pests” means that even if the pest comes into contact with a target, it does not stay on that place but leaves away immediately, and the composition of the present invention is corresponding to a contact repellent composition. That is, the pest repellent effect of the present invention is different from a repellent or an insect repellent that repels the pest such that a pest does not contact with the target, such as one that does not attract the pest to the target and one making the pest not approach the target, and an insecticide having an insecticidal activity against the pest and exterminating the pest.

The composition of the present invention exerts an effect of repelling pests in such a manner that even if a pest, such as a mosquito, lands on the target having the composition of the present invention applied or attached thereonto, the pest does not stay on that place but leaves away immediately. Specifically, the composition of the present invention has an effect of preventing the pest, such as a mosquito, from staying in a predetermined area on the skin surface of an animal, such a human, after landing thereon, for a time enough to pierce the animal, for example, 1 second or more. Such an effect is based on an unprecedented pest repellent principle, and is safe without side effects, such as chopped skin. In consequence, the composition of the present invention can be used as a pest stay inhibition composition.

In the present invention, the term “repellent sustaining effect against pests” means that after applying the composition of the present invention to the target, even after a lapse of time, the aforementioned repellent effect is sustained. In the following description, in the present invention, the repellent sustaining effect particularly against flying pests is expressed simply as “repellent sustaining effect”.

The composition of the present invention contains, as the component (A), at least one non-volatile liquid oily component selected from the group consisting of (a) a silicone oil, (b) an ester oil, (c) an ether oil, (d) a hydrocarbon oil, (e) an aliphatic alcohol, and (f) a polyhydric alcohol, the non-volatile liquid oily component having a surface tension at 25° C. of 40 mN/m or less and a viscosity at 23° C. as measured with a B-type rotational viscometer of 400 mPa·s or less. In view of the fact that the composition of the present invention is excellent in the repellent sustaining effect against pests, particularly flying pests by containing the component (A). Although the reason for this is not elucidated yet, the following may be considered.

The present inventors have found that a flying pest, such as a mosquito, has properties of avoiding stay on the surface where the limb gets wet in order to avoid the attractive force generated from the landing surface when the limb becomes wet. Since the limb of a flying pest, such as a mosquito, is hydrophobic, a liquid oily component having a surface tension at 25° C. of 40 mN/m or less has a high affinity with the limb of the flying pest. In addition, in a liquid oily component having a viscosity of 400 mPa·s or less, when the limb of the flying pest comes into contact with the liquid oily component, the contact area between the liquid oily component and the limb of the flying pest becomes sufficiently large within a short time. Therefore, it may be considered that when the flying pest lands on the surface onto which the component (A) is applied or attached, the limb gets wet, and at that time, the flying pest avoids the attractive force generated from the landing surface and jumps off without staying at the landing point.

The landing in the present invention refers to the contact of the flying pest, such as a mosquito, with the target for less than 1 second. In addition, the stay in the present invention refers to the matter that the flying pest, such as a mosquito, is kept in contact with the target for 1 second or more.

In the composition of the present invention, it may be considered that when a specified amount of the component (B) as mentioned later is further contained in addition to the component (A), and the component (B) is applied to limbs of a flying pest together with the component (A), the excellent repellent sustaining effect could be realized while reducing the strong odor derived from the component (B).

### <Component (A): Non-Volatile Liquid Oily Component>

The component (A) which the composition of the present invention contains is at least one non-volatile liquid oily component selected from the group consisting of (a) a silicone oil, (b) an ester oil, (c) an ether oil, (d) a hydrocarbon oil, (e) an aliphatic alcohol, and (f) a polyhydric alcohol, the non-volatile liquid oily component having a surface tension at 25° C. of 40 mN/m or less and a viscosity at 23° C. as measured with a B-type rotational viscometer of 400 mPa·s or less. The composition of the present invention suppresses a base material odor of the component (A) when further combined with the component (B) as mentioned later in addition to the component (A) and suppresses unnecessary volatilization of the component (B). Moreover, it may be considered that the component (B) together with the component (A) could be applied to the limbs of the flying pest, and an excellent repellent sustaining time could be realized.

The component (A) is a non-volatile oil which is preferably liquid at 20° C., more preferably liquid at 15° C., and still more preferably liquid at 10° C. from the viewpoint of facilitating application to the skin and improving the repellent sustaining effect.

The term “liquid” of the liquid oily component means one which is determined to be a liquid in a liquid-solid determination test according to the American Society for Testing and Materials Standards “ASTM D4359-90: Standard Test Method for Determining Whether a Material is a Liquid or Solid”.

The component (A) is preferably a sparingly water-soluble or water-insoluble component from the viewpoint of improving the repellent sustaining effect against pests. Specifically, the dissolution amount in 100 g of water at 20° C. is preferably 1 g or less, more preferably 0.5 g or less, and still more preferably 0.1 g or less, and still more preferably, it is substantially 0 g.

The liquid oily component of the component (A) which is used in the present invention is a non-volatile liquid oily component from the viewpoint of improving the repellent sustaining effect. Here, the non-volatile liquid oily component in the present invention is one in which a volatilization rate after drying at 25° C. for 60 minutes at 1 atm is 50% or less, and preferably one in which a volatilization rate after drying at 25° C. for 120 minutes at 1 atm is 50% or less.

The evaluation of volatility is measured according to the German test standard DIN 53249, and specifically, it is performed by the following procedures 1 to 4.

1. The weight (P (g)) of a round filter paper having a diameter of 150 mm is measured.

2. A sample of 0.3 g of the component (A) is dropped on the round filter paper with a pipette, and immediately thereafter, the weight (W₀ (g)) of the filter paper is measured.

3. The weight of the filter paper is measured by weighing with accuracy of about 0.001 g at 25° C. in 5 minute intervals in the absence of aeration. After measuring 2, the weight of the filter paper measured after a lapse of 60 minutes is designated as W₆₀ (g).

4. A value derived from the calculation equation {((W₀−P)−(W₆₀−P))/(W₀−P)}×100 is designated as the volatilization rate (%).

As the volatilization rate is lower, on the occasion of applying onto the skin, the liquid oily component remains for a longer time, and therefore, the repellent sustaining effect becomes higher.

In the case of using two or more liquid oily components, the volatilization rate of the non-volatile liquid oily component means a volatilization rate as a mixture of the two or more liquid oily components. In consequence, so long as the volatilization rate of the mixture falls within the aforementioned range, liquid oily components having a volatilization rate of more than 50% after drying at 25° C. for 60 minutes at 1 atm may be combined and used.

The surface tension at 25° C. of the component (A) is preferably 15 mN/m or more, and more preferably 17 mN/m or more from the viewpoint of availability, and it is 40 mN/m or less, preferably 30 mN/m or less, more preferably 28 mN/m or less, still more preferably 25 mN/m or less, yet still more preferably 23 mN/m or less, and even yet still more preferably 21 mN/m or less from the viewpoint of improving the repellent sustaining effect. In addition, even a material having a surface tension at 25° C. of more than 40 mN/m by itself develops the repellent sustaining effect so long as it is mixed with other liquid oily component to lower the surface tension.

The viscosity at 23° C. of the component (A) as measured with a B-type rotational viscometer is preferably 1 mPa·s or more from the viewpoint of suppressing volatility and improving the repellent sustaining effect, and it is 400 mPa·s or less, preferably 300 mPa·s or less, more preferably 210 mPa·s or less, still more preferably 100 mPa·s or less, yet still more preferably 60 mPa·s or less, even yet still more preferably 40 mPa·s or less, and even still more preferably 30 mPa·s or less from the viewpoint of improving the repellent sustaining effect. In the case of using two or more liquid oily components having a different viscosity from each other, the viscosity as a mixture of these liquid oily components is meant.

The surface tension and the viscosity of the component (A) are measured by the methods described in the section of Examples.

### (a) Silicone Oil

As the silicone oil, at least one selected from the group consisting of dimethylpolysiloxane, dimethiconol (dimethylpolysiloxane having a hydroxy group at the terminal), methylphenylpolysiloxane, and modified silicone is preferred from the viewpoint of improving the repellent sustaining effect.

Examples of the modified silicone include amino-modified silicone (dimethylpolysiloxane having an amino group), polyether-modified silicone, glyceryl-modified silicone, amino derivative silicone, carboxy-modified silicone, fatty acid-modified silicone, alcohol-modified silicone, aliphatic alcohol-modified silicone, epoxy-modified silicone, fluorine-modified silicone, and alkyl-modified silicone.

Of the silicone oils, at least one selected from the group consisting of dimethylpolysiloxane, dimethiconol, methylphenylpolysiloxane, and modified silicone is preferred, at least one selected from the group consisting of dimethylpolysiloxane, dimethiconol, and polyether-modified silicone is more preferred, and dimethylpolysiloxane is still more preferred from the viewpoint of improving the repellent sustaining effect.

Examples of the dimethylpolysiloxane include at least one selected from the group consisting of a linear dimethylpolysiloxane and a cyclic dimethylpolysiloxane. Of these, a linear dimethylpolysiloxane is more preferred from the viewpoint of improving the repellent sustaining effect.

Examples of a commercially available product of the linear dimethylpolysiloxane include KF-96 Series, manufactured by Shin-Etsu Chemical Co., Ltd.; SH200C Series, 2-1184 Fluid, manufactured by Dow Corning Toray Co., Ltd.; and Silsoft DML, Element 14 PDMS 5-JC, Element 14 PDMS 10-JC, and Element 14 PDMS 20-JC, all of which are manufactured by Momentive Performance Materials, Inc.

### (b) Ester Oil

As the ester oil, any of ester oils represented by the following general formulae (1) to (3) and a dialkyl carbonate compound represented by the following general formula (4) are preferred from the viewpoint of improving the repellent sustaining effect.

R¹—COO—R² (1)

In the general formula (1), R¹ represents a linear or branched alkyl group having 7 or more and 23 or less carbon atoms or an aromatic hydrocarbon group having 6 or more and 24 or less carbon atoms, which may be substituted with a hydroxy group; and R² represents a linear or branched alkyl group or alkenyl group having 1 or more and 22 or less carbon atoms.

In the case where R¹ is an alkyl group, the carbon number thereof is preferably 7 or more, and more preferably 9 or more from the viewpoint of improving the repellent sustaining effect, and it is preferably 21 or less, and more preferably 17 or less from the viewpoint of facilitating a feeling on the occasion of applying onto the skin. In addition, in the case where R¹ is an aromatic hydrocarbon group, the carbon number thereof is preferably 8 or more, and more preferably 10 or more from the viewpoint of improving the repellent sustaining effect, and it is preferably 22 or less, and more preferably 20 or less from the viewpoint of facilitating a feeling on the occasion of applying onto the skin.

R² is a linear or branched alkyl group or alkenyl group having preferably 20 or less carbon atoms, and more preferably 18 or less carbon atoms from the viewpoint of facilitating a feeling on the occasion of applying onto the skin. In addition, at least one of R¹ and R² is preferably a branched alkyl group from the viewpoint of facilitating a feeling on the occasion of applying onto the skin.

Examples of the ester oil represented by the general formula (1) is at least one selected from the group consisting of myristyl 2-ethylhexanoate, cetyl 2-ethylhexanoate, stearyl 2-ethylhexanoate, isodecyl octanoate, isocetyl octanoate, isononyl isononanoate, isotridecyl isononanoate, cetearyl isononanoate, octyl propylheptanoate, methyl laurate, isopropyl myristate, octyldodecyl myristate, isopropyl palmitate, 2-ethylhexyl palmitate, isocetyl palmitate, 2-ethylhexyl stearate, isocetyl stearate, isotridecyl stearate, isopropyl isostearate, octyl isostearate, isocetyl isostearate, isostearyl isostearate, 2-ethylhexyl hydroxystearate, methyl oleate, oleyl oleate, isobutyl oleate, oleyl erucate, an alkyl benzoate (carbon number of alkyl: 12 to 15), and diethylhexyl naphthalenedicarboxylate.

(R³O)—CH₂CH(OR⁴)—CH₂(OR⁵) (2)

In the general formula (2), R³, R⁴, and R⁵ are each independently a hydrogen atom or a group represented by the following general formula (2-1), provided that all of them are not a hydrogen atom at the same time.

—CO—R⁶ (2-1)

In the formula, R⁶ represents an alkyl group or alkenyl group having 7 or more and 23 or less carbon atoms, and preferably 17 or less carbon atoms, which may be substituted with a hydroxy group.

Examples of the ester oil represented by the general formula (2) include at least one selected from the group consisting of glyceryl tri-2-ethylhexanoate and glyceryl tricaprylate. These may also be a plant-derived ester oil, such as jojoba oil, olive oil, sunflower oil, soybean oil, peanut oil, rapeseed oil, almond oil, palm oil, coconut oil, castor oil, wheat germ oil, grape seed oil, thistle oil, evening primrose oil, macadamia nut oil, corn germ oil, and avocado oil.

R⁷O-(AO)ₘ—COR⁸ (3)

In the general formula (3), R⁷ represents an aromatic hydrocarbon group having 6 or more and 20 or less carbon atoms; R⁸ represents an alkyl group or alkenyl group having 1 or more and 23 or less carbon atoms; AO represents an alkyleneoxy group having 2 or more and 4 or less carbon atoms; and m represents an average addition molar number of 1 or more and 50 or less.

R⁷ is an aromatic hydrocarbon group having preferably 6 or more carbon atoms from the viewpoint of improving the repellent sustaining effect, and preferably 12 or less carbon atoms, and more preferably 10 or less carbon atoms from the viewpoint of facilitating a feeling on the occasion of applying onto the skin, and R⁷ is still more preferably a benzyl group.

R⁸ is an alkyl group having preferably 7 or more carbon atoms, and more preferably 11 or more carbon atoms from the viewpoint of improving the repellent sustaining effect, and preferably 21 or less carbon atoms, and more preferably 15 or less carbon atoms from the viewpoint of facilitating a feeling on the occasion of applying onto the skin.

The AO group is preferably a propyleneoxy group from the viewpoint of improving the repellent sustaining effect; and m is preferably 1 or more and 10 or less, and more preferably 1 or more and 5 or less from the viewpoint of improving the repellent sustaining effect and the viewpoint of facilitating a feeling on the occasion of applying onto the skin.

Examples of the ester oil represented by the general formula (3) include at least one selected from the group consisting of an ester of a propylene oxide 3 mol adduct of benzyl alcohol and myristic acid (CRODAMOL STS, manufactured by Croda) and an ester of a propylene oxide 3 mol adduct of benzyl alcohol and 2-ethylhexanoic acid (CRODAMOL SFX, manufactured by Croda).

R⁹—O—(CH₂CH₂O)ᵥ—CO—(OCH₂CH₂)_{w}—OR¹⁰ (4)

In the general formula (4), R⁹ and R¹⁰ each independently represent an alkyl group or alkenyl group having 6 or more and 22 or less carbon atoms; and v and w are each independently 0 or an average addition molar number of 1 or more and 50 or less.

R⁹ and R¹⁰ are each an alkyl group having preferably 8 or more carbon atoms from the viewpoint of improving the repellent sustaining effect, and preferably 18 or less carbon atoms, and more preferably 12 or less carbon atoms from the viewpoint of facilitating a feeling on the occasion of applying onto the skin.

v and w are each preferably 0 or a number of 1 or more and 5 or less, and more preferably 0 from the viewpoint of facilitating a feeling on the occasion of applying onto the skin.

Examples of the dialkyl carbonate compound represented by the general formula (4) include dioctyl carbonate (Cetiol CC, manufactured by Cognis).

Examples of ester oils other than those mentioned above include an ester of a polyvalent carboxylic acid and an alcohol; and an ester of a polyhydric alcohol excluding glycerin and a fatty acid.

Specific examples thereof include at least one selected from the group consisting of diisopropyl dimerate, diisopropyl adipate, diethoxyethyl succinate, 2-ethylhexyl succinate, propanediol dicaprate, neopentyl glycol dicaprate, and neopentyl glycol di-2-ethylhexanoate. Of these, an ester of neopentyl glycol and a fatty acid is preferred, and at least one selected from neopentyl glycol dicaprate and neopentyl glycol di-2-ethylhexanoate is more preferred from the viewpoint of improving the repellent sustaining effect.

Of the aforementioned ester oils (b), at least one selected from the group consisting of the ester oil represented by the general formula (1) and an ester of neopentyl glycol and a fatty acid is preferred.

### (c) Ether Oil

As the ether oil, a dialkyl ether compound represented by the following general formula (5) or a polyoxyalkylene alkyl ether compound represented by the following general formula (6) is preferred from the viewpoint of improving the repellent sustaining effect.

R¹¹—O—R¹² (5)

In the general formula (5), R¹¹ and R¹² each independently represent a linear or branched alkyl group or alkenyl group having 6 or more and 22 or less carbon atoms or an aromatic hydrocarbon group having 6 or more and 24 or less carbon atoms.

R¹¹ and R¹² are each preferably an alkyl group from the viewpoint of improving the repellent sustaining effect, and the carbon number thereof is preferably 8 or more from the viewpoint of improving the repellent sustaining effect, and it is preferably 18 or less, more preferably 16 or less, and still more preferably 12 or less from the viewpoint of facilitating a feeling on the occasion of applying onto the skin.

Examples of the dialkyl ether compound represented by the general formula (5) include dihexyl ether, dioctyl ether (Cetiol OE, manufactured by Cognis), dicaprylyl ether, and cetyl-1,3-dimethylbutyl ether (ASE-166K, manufactured by Kao Corporation).

R¹³—O—(PO)ᵣ(EO)ₛ—H (6)

In the general formula (6), R¹³ represents an alkyl group or alkenyl group having 6 or more and 22 or less carbon atoms; PO represents a propyleneoxy group; EO represents an ethyleneoxy group; r is an average addition molar number of 0.1 or more and 15 or less; and s is an average addition molar number of 0 or more and 10 or less. In the case where s is not 0, an addition form of each of PO and EO may be a random form or may be a block form.

The carbon number of R¹³ is preferably 8 or more from the viewpoint of improving the repellent sustaining effect, and it is preferably 20 or less, more preferably 18 or less, and still more preferably 12 or less from the viewpoint of facilitating a feeling on the occasion of applying onto the skin.

The average addition molar number r is preferably 1 or more, more preferably 2 or more, and still more preferably 3 or more from the viewpoint of improving the repellent sustaining effect, and it is preferably 13 or less, and more preferably 10 or less from the viewpoint of facilitating a feeling on the occasion of applying onto the skin; and the average addition molar number s is preferably 5 or less, more preferably 1 or less, and still more preferably 0 from the viewpoint of facilitating a feeling on the occasion of applying onto the skin.

As the polyoxyalkylene alkyl ether compound represented by the general formula (6), at least one selected from the group consisting of polypropylene glycol; and polyoxypropylene octyl ether, polyoxypropylene decyl ether, and polyoxypropylene lauryl ether, in which the average addition molar number r of the propyleneoxy group is 3 or more and 10 or less, is preferred.

Of the aforementioned ether oils (c), the ether oil represented by the general formula (5) is preferred from the viewpoint of improving the repellent sustaining effect.

### (d) Hydrocarbon Oil

Examples of the hydrocarbon oil include a liquid paraffin, a liquid isoparaffin, squalane, isohexadecane, isoeicosane, hydrogenated polyisobutene, a light liquid isoparaffin, a heavy liquid isoparaffin, an α-olefin oligomer, and a cycloparaffin.

Of these, at least one selected from the group consisting of a liquid paraffin, a liquid isoparaffin, and squalane is preferred from the viewpoint of improving the repellent sustaining effect and the viewpoint of facilitating a feeling on the occasion of applying onto the skin.

### (e) Aliphatic Alcohol

Examples of the aliphatic alcohol include a monohydric chain or cyclic aliphatic alcohol, with a monohydric chain aliphatic alcohol being preferred. The aliphatic alcohol is preferably an aliphatic alcohol having 14 or more carbon atoms, and more preferably 18 or more carbon atoms from the viewpoint of improving the repellent sustaining effect, and preferably 28 or less carbon atoms, more preferably 24 or less carbon atoms, and still more preferably 22 or less carbon atoms from the viewpoint of facilitating a feeling on the occasion of applying onto the skin.

Although the aforementioned aliphatic alcohol may be any of a chain aliphatic alcohol and a branched aliphatic alcohol, and it may be any of a saturated aliphatic alcohol and an unsaturated aliphatic alcohol, it is preferably a branched aliphatic saturated alcohol from the viewpoint of improving the repellent sustaining effect and the viewpoint of facilitating a feeling on the occasion of applying onto the skin.

Examples of the linear aliphatic alcohol include oleyl alcohol, and examples of the branched aliphatic saturated alcohol include butyl octanol, butyl decanol, hexyl decanol, and octyl dodecanol.

Of these, a branched aliphatic saturated alcohol is preferred, and at least one selected from the group consisting of hexyl decanol, hexyl dodecanol, and octyl dodecanol is preferred from the viewpoint of improving the repellent sustaining effect and the viewpoint of facilitating a feeling on the occasion of applying onto the skin.

### (f) Polyhydric Alcohol

Examples of the polyhydric alcohol include an aliphatic alcohol having 2 or more carbon atoms, an aromatic alcohol, and a sugar alcohol having 4 or more carbon atoms, and the polyhydric alcohol may be either saturated or unsaturated. However, at least one selected from the group consisting of an aliphatic alcohol having 2 or more and 10 or less carbon atoms, an aromatic alcohol, and a sugar alcohol having 4 or more and 10 or less carbon atoms is preferred.

Among the polyhydric alcohols, examples of the aliphatic alcohol having 2 or more carbon atoms include dihydric alcohols, such as ethylene glycol, propylene glycol, 1,2-butylene glycol, 1,3-butylene glycol, 1,2-pentanediol, 1,2-hexanediol, diethylene glycol, dipropylene glycol, and hexylene glycol.

Examples of the aforementioned sugar alcohol include sorbitol, erythritol, pentaerythritol, xylitol, and mannitol.

Of the aforementioned liquid oily components, from the viewpoint of improving the repellent sustaining effect, at least one selected from the group consisting of the silicone oil (a), the ester oil (b), the ether oil (c), and the hydrocarbon oil (d) is preferred; at least one selected from the group consisting of the silicone oil (a), the ester oil (b), and the hydrocarbon oil (d) is more preferred; at least one selected from the group consisting of the silicone oil (a) and the ester oil (b) is still more preferred; and the silicone oil (a) is yet still more preferred. Of the silicone oils (a), at least one selected from the group consisting of dimethylpolysiloxane, dimethiconol, methylphenylpolysiloxane, and modified silicone is preferred; at least one selected from the group consisting of dimethylpolysiloxane, dimethiconol, and polyether-modified silicone is more preferred; dimethylpolysiloxane is still more preferred; and linear dimethylpolysiloxane is yet still more preferred.

### (Content of Component (A))

The content of the component (A) in the composition of the present invention is 13% by mass or more, preferably 20% by mass or more, and more preferably 25% by mass or more from the viewpoint of improving the repellent sustaining effect, and it is 99.95% by mass or less, preferably 80% by mass or less, more preferably 50% by mass or less, still more preferably 40% by mass or less, and yet still more preferably 35% by mass or less from the viewpoint of improving the repellent sustaining effect, the viewpoint of guaranteeing long-term storage stability of the composition, the viewpoint of suppressing an odor derived from the component (A), and the viewpoint of improving a feeling of use of the composition. Then, the content of the component (A) in the composition of the present invention is 13 to 99.95% by mass, preferably 13 to 80% by mass, more preferably 13 to 50% by mass, still more preferably 20 to 40% by mass, and yet still more preferably 25 to 35% by mass.

### <Component (B): Fragrance>

The composition of the present invention contains, as the component (B), at least one fragrance selected from the group consisting of the following (B1) to (B9):

(B1) at least one lactone selected from the group consisting of octahydro-2H-1-benzopyran-2-one, gamma decalactone, delta decalactone, delta nonalactone, and gamma undecalactone,

(B2) at least one ketone selected from the group consisting of 9-ethylidene-3-oxatricyclo[6.2.1.0^{2,7}]undecan-4-one and octahydro-7-methyl-1,4-methanonaphthalene-6(2H)-one,

(B3) at least one aldehyde selected from the group consisting of 7-hydroxy-3,7-dimethyloctanal and octahydro-5-methoxy-4,7-methano-1H-indene-2-carboxyaldehyde,

(B4) at least one aromatic alcohol selected from the group consisting of phenylethyl methyl ethyl carbinol, cinnamic alcohol, and eugenol,

(B5) 2-(4-methyl-2-thiazolyl) ethanol,

(B6) ethyl-2-phenyl acetate,

(B7) (3-pentyloxan-4-yl) acetate,

(B8) phenylethyl dimethyl carbinyl acetate, and

(B9) methyl anthranilate.

The fragrance of the component (B) is considered as a substance that acts on the chemoreceptive system of a flying pest, such as a mosquito, to also have a repellent effect. By using the component (A) and the component (B) in combination, the pest repellent sustaining effect is synergistically improved as compared with the case where the component (A) or the component (B) is used alone.

The octahydro-2H-1-benzopyran-2-one is a compound also called “octahydrocoumarin”. The 7-hydroxy-3,7-dimethyloctanal is also called “hydroxycitronellal”; the octahydro-5-methoxy-4,7-methano-1H-indene-2-carboxyaldehyde is also called “scentenal”; the 2-(4-methyl-2-thiazolyl) ethanol is also called “sulfurol”; and the (3-pentyloxan-4-yl) acetate is also called “Jasmonyl”.

The component (B) can be used alone or in combination of two or more thereof. As for the component (B), from the viewpoint of suppressing a strong odor and the viewpoint of improving the repellent sustaining effect, at least one selected from the group consisting of octahydro-2H-1-benzopyran-2-one, gamma decalactone, gamma undecalactone, 9-ethylidene-3-oxatricyclo[6.2.1.0^{2,7}]undecan-4-one, octahydro-7-methyl-1,4-methanonaphthalene-6(2H)-one, 7-hydroxy-3,7-dimethyloctanal, octahydro-5-methoxy-4,7-methano-1H-indene-2-carboxyaldehyde, phenylethyl methyl ethyl carbinol, eugenol, 2-(4-methyl-2-thiazolyl) ethanol, (3-pentyloxan-4-yl) acetate, and methyl anthranilate is preferred; at least one selected from the group consisting of octahydro-2H-1-benzopyran-2-one, gamma undecalactone, 9-ethylidene-3-oxatricyclo[6.2.1.0^{2,7}]undecan-4-one, and (3-pentyloxan-4-yl) acetate is more preferred; at least one selected from the group consisting of octahydro-2H-1-benzopyran-2-one and 7-hydroxy-3,7-dimethyloctanal is still more preferred; and octahydro-2H-1-benzopyran-2-one is yet still more preferred.

### (Content of Component (B))

The content of the component (B) in the composition of the present invention is 0.05% by mass or more, preferably 0.1% by mass or more, more preferably 0.2% by mass or more, and still more preferably 0.3% by mass or more from the viewpoint of suppressing an odor derived from the component (A) and the viewpoint of improving the repellent sustaining effect. In addition, the content of the component (B) in the composition of the present invention is 3.5% by mass or less, preferably 2.5% by mass or less, more preferably 2.0% by mass or less, still more preferably 1.0% by mass or less, and yet still more preferably 0.7% by mass or less from the viewpoint of suppressing a strong odor derived from the component (B). Then, the content of the component (B) in the composition of the present invention is 0.05 to 3.5% by mass, preferably 0.1 to 2.5% by mass, more preferably 0.2 to 2.0% by mass, still more preferably 0.2 to 1.0% by mass, and yet still more preferably 0.3 to 0.7% by mass.

In the composition of the present invention, a mass ratio [(A)/(B)] of the component (A) to the component (B) is preferably 10 or more, more preferably 15 or more, still more preferably 30 or more, and yet still more preferably 40 or more from the viewpoint of suppressing an odor and the viewpoint of securing long-term storage stability of the composition, and it is preferably 400 or less, more preferably 300 or less, still more preferably 150 or less, yet still more preferably 120 or less, even yet still more preferably 100 or less, and even still more preferably 70 or less from the viewpoint of improving the pest repellent sustaining effect. Then, the mass ratio [(A)/(B)] of the component (A) to the component (B) is preferably 10 to 400, more preferably 15 to 300, still more preferably 15 to 150, yet still more preferably 15 to 150, even yet still more preferably 15 to 120, even still more preferably 15 to 100, even still more further preferably 30 to 100, and even yet still more further preferably 40 to 70.

### <Component (C): Water>

The composition of the present invention preferably contains water as the component (C) from the viewpoint of improving the repellent sustaining effect and the viewpoint of providing a composition with a good feeling of use. The content of the component (C) in the composition of the present invention is preferably 5% by mass or more, more preferably 10% by mass or more, still more preferably 35% by mass or more, and yet still more preferably 50% by mass or more from the viewpoint of improving the repellent sustaining effect and the viewpoint of providing a composition with a good feeling of use. In addition, it is preferably 86.95% by mass or less, more preferably 85% by mass or less, still more preferably 80% by mass or less, and yet still more preferably 75% by mass or less from the viewpoint of improving the repellent sustaining effect. Then, the content of the component (C) in the composition of the present invention is preferably 5 to 86.95% by mass, more preferably 5 to 85% by mass, still more preferably 10 to 80% by mass, yet still more preferably 35 to 75% by mass, and even yet still more preferably 50 to 75% by mass.

The present invention can be applied to various forms of composition, and for example, it can be used for a moisture-free nonaqueous composition, a water-in-oil type composition, an oil-in-water type composition, and the like. However, an oil-in-water type composition is preferred from the viewpoint of suppressing an odor derived from the component (A). In the case of an oil-in-water type composition, the content of the component (C) in the composition is preferably 35% by mass or more, more preferably 40% by mass or more, and still more preferably 50% by mass or more from the viewpoint of suppressing an odor derived from the component (A) and the viewpoint of securing long-term storage stability of the composition. In addition, it is preferably 86.95% by mass or less, more preferably 80% by mass or less, and still more preferably 75% by mass or less from the viewpoint of improving the repellent sustaining effect.

From the viewpoint of improving the repellent sustaining effect, a water-in-oil type composition is preferred. In the case of a water-in-oil type composition, the content of the component (C) in the composition is preferably 5% by mass or more, more preferably 10% by mass or more, and still more preferably 15% by mass or more from the viewpoint of facilitating a feeling on the occasion of applying onto the skin. In addition, it is preferably 40% by mass or less, more preferably 30% by mass or less, and still more preferably 25% by mass or less from the viewpoint of improving the repellent sustaining effect.

In the case where the composition of the present invention contains the component (C), a mass ratio [(A)/(C)] of the component (A) to water is preferably 0.05 or more, more preferably 0.1 or more, still more preferably 0.15 or more, and yet still more preferably 0.3 or more from the viewpoint of improving the repellent sustaining effect, and it is preferably 10 or less, more preferably 3 or less, still more preferably 1 or less, and yet still more preferably 0.7 or less from the viewpoint of securing long-term storage stability of the composition and the viewpoint of providing a composition with a good feeling of use.

### <Component (D): Thickener>

The composition of the present invention can further contain a thickener as the component (D). As the thickener, one having an appropriate emulsifying ability (namely, surface active ability) is preferred from the viewpoint of regulating fluidity after applying onto the skin, to improve the repellent sustaining effect, the viewpoint of allowing each of the components to well disperse or dissolve, to make it possible to secure excellent coatability onto the skin, and the viewpoint of securing long-term storage stability of the composition. In the present invention, an agent having an emulsifying ability and a thickening effect is the thickener.

Examples of the component (D) include water-soluble cationic polymers, anionic polymers, nonionic polymers, and amphoteric polymers or dipolar polymers.

Specifically, examples of the cationic polymer include hydroxyethyl cellulose (polyquaternium-10) having an O-[2-hydroxy-3-(trimethylammonio)propyl] chloride group, vinylpyrrolidone-dimethylaminomethylethyl methacrylate copolymer diethyl sulfate (polyquaternium-11), and a methylvinylimidazolium chloride/vinylpyrrolidone copolymer.

Specifically, examples of the anionic polymer include a carboxyvinyl polymer, carboxymethyl cellulose, carrageenan, xanthan gum, polystyrene sulfonate, agar, gatch gum, karaya gum, pectin, an alginate salt, an acrylic acid/alkyl methacrylate copolymer, an (acrylic acid Na/acryloyl dimethyl taurine Na) copolymer, polyacrylamide, an (acryloyl dimethyl taurine ammonium/vinylpyrrolidone) copolymer, an (acrylate/alkyl acrylate (C10 to C30)) cross polymer, an (acryloyl dimethyl taurine ammonium/beheneth-25 methacrylate) cross polymer, a (hydroxyethyl acrylate/acryloyldimethyltaurine Na) copolymer, an (acrylamide/ammonium acrylate) copolymer, an (acrylic acid Na/acryloyldimethyltaurine/dimethylacrylamide) cross polymer, polyacrylate-13, polyacrylate cross polymer-6, an alkali metal salt of poly(acrylic acid), and hyaluronic acid or an alkali metal salt thereof.

Specifically, examples of the nonionic polymer include a cellulose ether (e.g., hydroxybutylmethyl cellulose, hydroxypropyl cellulose, hydroxypropylmethyl cellulose, ethylhydroxyethyl cellulose, and hydroxyethyl cellulose), propylene glycol alginate, poly(ethylene oxide), polyvinyl alcohol, polyvinylpyrrolidone, hydroxypropyl guar gum, locust bean gum, amylose, hydroxyethyl amylose, starch, a starch derivative, and mixtures thereof.

Specifically, examples of the amphoteric polymer or dipolar polymer include an octyl acrylamide/acrylate/butylaminoethyl methacrylate copolymer, polyquaternium-47, and polyquaternium-43.

The component (D) can be used alone or in combination of two or more thereof. From the viewpoint of regulating fluidity after applying onto the skin, to improve the sustainability of pest repellent effect, the viewpoint of allowing each of the components to well disperse or dissolve, to make it possible to secure excellent coatability, and the viewpoint of securing long-term storage stability of the composition, the component (D) is preferably at least one selected from the group consisting of anionic polymers and nonionic polymers; preferably at least one selected from the group consisting of a carboxyvinyl polymer, an acrylic acid/alkyl methacrylate copolymer, an (acrylic acid Na/acryloyl dimethyl taurine Na) copolymer, an (acrylate/alkyl acrylate (C10 to C30)) cross polymer, an (acryloyl dimethyl taurine ammonium/beheneth-25 methacrylate) cross polymer, and a cellulose ether; and more preferably at least one selected from the group consisting of an (acrylic acid Na/acryloyl dimethyl taurine Na) copolymer, an (acrylate/alkyl acrylate (C10 to C30)) cross polymer, and an (acryloyl dimethyl taurine ammonium/beheneth-25 methacrylate) cross polymer.

Examples of a commercially available product of the component (D) include CARBOPOL 980, CARBOPOL 981, CARBOPOL 1342, CARBOPOL ETD2020, PEMULEN TR-1, and PEMULEN TR-2, all of which are manufactured by Lubrizol Advanced Materials, Inc.; Aculyn 22, manufactured by The Dow Chemical Company; and Aristoflex AVC and Aristoflex HMB, all of which manufactured by Clariant Iberica Production S.A. The thickener can also be blended as a dispersion liquid thereof having been dispersed in a dispersion medium.

The content of the component (D) in the composition of the present invention is preferably 0.01% by mass or more, more preferably 0.05% by mass or more, and still more preferably 0.1% by mass or more from the viewpoint of improving the repellent sustaining effect, the viewpoint of allowing each of the components to well disperse or dissolve, to make it possible to secure excellent coatability, and the viewpoint of securing long-term storage stability of the composition, and it is preferably 5% by mass or less, more preferably 3% by mass or less, and still more preferably 1% by mass or less from the same viewpoints. In the case where the composition of the present invention contains the thickener having a surface active ability, the content of other surfactant is preferably 1.5% by mass or less, and more preferably 1% by mass or less in the composition.

### <Other Components>

The composition of the present invention can appropriately contain other components than those as mentioned above, for example, a surfactant, a preservative, a coloring agent, a moisturizer, a fragrance other than the component (B), and a pH adjuster, within a range where the effects of the present invention are not impaired. In addition, medicinal ingredients or physiologically active ingredients, such as a vitamin, a blood circulation accelerator, an active oxygen scavenger, an anti-inflammatory agent, a whitening agent, and a disinfectant, can also be contained. It can also be used for other applications, for example, the fragrance is used as the disinfectant.

From the viewpoint of preventing the user from occurrence of allergy or chopped skin, it is preferred that the composition of the present invention contains the component (A) and the component (B) as repellent components for pest repellence and does not contain an effective amount of other pest repellent.

Even when the composition of the present invention does not contain an effective amount of other pest repellent than the component (A) and the component (B), it has the repellent sustaining effect. In other words, even in the case where the composition of the present invention contains an existing pest repellent other than the component (A) and the component (B) in an amount of less than the lower limit of the effective amount, so long as a pest lands but does not stay on that place, the effect of preventing the pest from staying is developed. That is, the composition of the present invention may not substantially contain an existing pest repellent other than the component (A) and the component (B).

Here, the phrase “does not contain an effective amount” of other pest repellent than the component (A) and the component (B) generally means that the content of the other pest repellent than the component (A) and the component (B) is preferably 15% by mass or less, more preferably 10% by mass or less, still more preferably 5% by mass or less, yet still more preferably 4% by mass or less, even yet still more preferably 3% by mass or less, and even still more preferably 1% by mass or less in the composition of the present invention.

As for the effective amount of the existing pest repellent, for example, the minimum effective amount and the like published by the manufacturer and the like of each repellent product can be made by reference. More specifically, the effective amount of DEET: N,N-diethyl-toluamide is 4% by mass or more, and preferably 10% by mass or more; the effective amount of Icaridin: 1-methylpropyl-2-(2-hydroxyethyl)-1-piperidine carboxylate is 4% by mass or more; the effective amount of IR3535: ethyl 3-(acetylbutyl)aminopropionate is 4% by mass or more; and the effective amount of citronella oil is 10% by mass or more, each of these compounds being an existing pest repellent as mentioned later.

The effective amount of the existing pest repellent can also be measured by a repellent evaluation test as mentioned below.

### (Repellent Evaluation Test)

100 female mosquitoes (Aedes albopictus) that have been mated are placed in a plastic cage (30×30×30 cm: BugDorm-1 cage) surrounded by a mesh. An arm is inserted into a KUALATEC Super Long Glove (50 cm) (available from AS ONE Corporation, Catalog No.: 3-6432-02) with a cut of a rectangular shape having a size of 5 cm in length×4 cm in width on the elbow side of about 15 cm from the wrist. The arm is inserted into the cage in a state that nothing is applied to an exposed skin portion from the cut, and it is confirmed that the mosquitoes land in two locations of the exposed skin portion within 2 minutes and then stay for at least 1 second. In the case where the mosquito does not stay for at least one second, a new mosquito is prepared. The “stay for at least 1 second” is hereinafter referred to simply as “stay”.

The test of an evaluation sample that is a solution of the pest repellent active ingredient is performed by adjusting the concentration thereof with ethanol such that it can be applied at a coverage of 2 mg/cm² to the exposed skin portion (5 cm×4 cm).

Using a pipetman, the solution whose concentration has been adjusted is placed in the exposed skin portion and applied so as to spread over the entire exposed skin portion (required solution volume: 40 to 50 μl). Subsequently, after allowing to stand for 3 minutes, the test is started.

The test is performed by inserting the arm applied with the evaluation sample into the cage for 2 minutes and counting the number of stays. The test is terminated when the vehicle has stayed twice in total, and the test is performed in which the arm is inserted for 2 minutes every 30 minutes until the test is completed. In the case where there is a second stay at 30 minutes, the repellent effect duration is determined to be 0 minute, and in the case where there is a second stay at 60 minutes, the repellent effect duration is determined to be 30 minutes. The test is performed on three subjects, and an average repellent effect duration is calculated.

In the present test, the concentration of the pest repellent at which an average repellent effect duration of 2 hours or more in average is exhibited can be taken as the effective concentration (effective amount) of the pest repellent.

In view of the fact that even when the composition of the present invention does not contain an effective amount of other pest repellent than the component (A) and the component (B), it has the repellent sustaining effect, it is rather preferred that the composition of the present invention does not substantially contain other pest repellent than the component (A) and the component (B). In the composition of the present invention, the content of the other pest repellent than the component (A) and the component (B) is preferably 0.5% by mass or less, more preferably 0.1% by mass or less, still more preferably 0.01% by mass or less, and yet still more preferably substantially 0% by mass.

Examples of the existing pest repellent other than the component (A) and the component (B) include known pest repellent compounds, such as DEET, Icaridin, dimethyl phthalate, 2-ethyl-1,3-hexanediol, p-menthane-3,8-diol, karan-3,4-diol, di-n-butyl succinate, hydroxyanisole, rotenone, ethyl 3-(acetylbutyl)aminopropionate, citronellol, eucalyptol, α-pinene, geraniol, citronellal, camphor, linalool, and 2-undecanone, and besides, repellent refined oils, such as citronella oil and lemongrass oil. The “repellent refined oil” means one having a pest repellent effect among refined oils (essential oils) obtained by extraction, distillation, compression, or the like of a component contained in a plant.

The composition of the present invention can be produced by a conventional method. For example, the composition of the present invention can be produced by blending the components (A) and (B) and optionally other component and agitating the blend with a known apparatus.

Although the pest targeted by the composition of the present invention is not particularly limited, the composition of the present invention is more effective for flying pests.

The “flying pests” refer to pests that approach animals, such as humans, while flying and suck blood from their skins, pests that carry pathogenic bacteria or the like while flying without sucking blood, and pests in which their own flying gives a feeling of displeasure to humans.

Specific examples of the flying pests include house mosquitoes, such as Culex pipiens pallens, Culex tritaeniorhynchus, Culex pipiens molestus, and Culex quinquefasciatus; mosquitoes, such as Aedes aegypti, Aedes albopictus, Anopheles sinensis, Aedes togoi, Anopheles gambiae, and Anopheles stephensi; chironomidae, such as Chironomus yoshimatsui and Propsilocerus akamusi; black flies, such as Twinnia japonensis, Prosimulium yezoense, and Odagmia aokii; flies, such as Musca domestica, Muscina stabulans, Fannia canicularis, Calliphoridae, Sarcophagidae, Delia platura, Delia antiqua, fruit flies, fruit vinegar flies, moth flies, tsetse flies, and Stomoxys calcitrans; horseflies, such as Tabanus stygius, Tabanus trigonus, Chrysops suavis, and Haematopota pluvialis; biting midges, such as Leptoconops nipponensis, Culicoides sumatrae, and Culicoides arakawae; and bees, such as Vespa simillima xanthoptera, Polistes jokahamae, and honeybees.

The composition of the present invention exhibits an excellent repellent sustaining effect particularly against mosquitoes among them. The composition of the present invention exhibits an excellent repellent sustaining effect against Culex pipiens pallens, Culex tritaeniorhynchus, Culex pipiens molestus, Culex quinquefasciatus, Aedes aegypti, and Aedes albopictus among the aforementioned mosquitoes.

### [Method for Repelling Pests and Method for Inhibiting Pest Stay]

The method for repelling pests of the present invention is a method including applying the pest repellent composition of the present invention onto the skin surface of a human.

The method for inhibiting pest stay of the present invention is a method including attaching the pest stay inhibition composition of the present invention onto limbs of a pest, particularly a flying pest, to prevent the pest from staying on the skin. These methods are also hereunder collectively referred to as “method of the present invention”.

Here, the phrase “applying onto the skin surface” includes not only directly applying the composition onto the skin surface by a finger or the like but also attaching the composition onto the skin surface by spraying or the like.

The amount of the composition which is applied onto the skin surface is preferably 0.1 mg or more, more preferably 0.2 mg or more, and still more preferably 0.25 mg or more per 1 cm² from the viewpoint of improving the repellent sustaining effect. In addition, an upper limit of the application amount is preferably 10 mg or less, more preferably 8 mg or less, and still more preferably 5 mg or less per 1 cm² from the viewpoint of suppression of stickiness and economy.

From the viewpoint of providing a repellent composition which is excellent in the repellent sustaining effect against a mosquito, is safe, is suppressed in the strong odor derived from the repellent component, and is excellent in a feeling of use, the composition of the present invention is preferably an oil-in-water type mosquito repellent composition or mosquito stay inhibition composition containing the following components (A) to (C) and having the content of other pest repellent than the component (A) and the component (B) of 15% by mass or less:

(A) 13% by mass or more and 50% by mass or less of at least one non-volatile liquid oily component selected from the group consisting of a silicone oil, an ester oil, an ether oil, a hydrocarbon oil, an aliphatic alcohol, and a polyhydric alcohol, the non-volatile liquid oily component having a surface tension at 25° C. of 40 mN/m or less and a viscosity at 23° C. as measured with a B-type rotational viscometer of 400 mPa·s or less;

(B) 0.05% by mass or more and 3.5% by mass or less of at least one fragrance selected from the group consisting of the following (B1) to (B9):

(B1) at least one lactone selected from the group consisting of octahydro-2H-1-benzopyran-2-one, gamma decalactone, delta decalactone, delta nonalactone, and gamma undecalactone,

(B2) at least one ketone selected from the group consisting of 9-ethylidene-3-oxatricyclo[6.2.1.0^{2,7}]undecan-4-one and octahydro-7-methyl-1,4-methanonaphthalene-6(2H)-one,

(B3) at least one aldehyde selected from the group consisting of 7-hydroxy-3,7-dimethyloctanal and octahydro-5-methoxy-4,7-methano-1H-indene-2-carboxyaldehyde,

(B4) at least one aromatic alcohol selected from the group consisting of phenylethyl methyl ethyl carbinol, cinnamic alcohol, and eugenol,

(B5) 2-(4-methyl-2-thiazolyl) ethanol,

(B6) ethyl-2-phenyl acetate,

(B7) (3-pentyloxan-4-yl) acetate,

(B8) phenylethyl dimethyl carbinyl acetate, and

(B9) methyl anthranilate; and

(C) 35% by mass or more and 86.95% by mass or less of water.

From the viewpoint of providing a repellent composition which is excellent in the repellent sustaining effect against a mosquito, is safe, is suppressed in the strong odor derived from the repellent component, and is excellent in a feeling of use, the composition of the present invention is preferably an oil-in-water type mosquito repellent composition or mosquito stay inhibition composition containing the following components (A) to (C), with a mass ratio [(A)/(B)] of the component (A) to the composition (B) being 10 or more and 400 or less, and having the content of other pest repellent than the component (A) and the component (B) of 15% by mass or less:

(A) 13% by mass or more and 50% by mass or less of at least one non-volatile liquid oily component selected from the group consisting of a silicone oil, an ester oil, an ether oil, a hydrocarbon oil, an aliphatic alcohol, and a polyhydric alcohol, the non-volatile liquid oily component having a surface tension at 25° C. of 40 mN/m or less and a viscosity at 23° C. as measured with a B-type rotational viscometer of 400 mPa·s or less;

(B) 0.05% by mass or more and 3.5% by mass or less of at least one fragrance selected from the group consisting of the following (B1) to (B9):

(B1) at least one lactone selected from the group consisting of octahydro-2H-1-benzopyran-2-one, gamma decalactone, delta decalactone, delta nonalactone, and gamma undecalactone,

(B2) at least one ketone selected from the group consisting of 9-ethylidene-3-oxatricyclo[6.2.1.0^{2,7}]undecan-4-one and octahydro-7-methyl-1,4-methanonaphthalene-6(2H)-one,

(B3) at least one aldehyde selected from the group consisting of 7-hydroxy-3,7-dimethyloctanal and octahydro-5-methoxy-4,7-methano-1H-indene-2-carboxyaldehyde,

(B4) at least one aromatic alcohol selected from the group consisting of phenylethyl methyl ethyl carbinol, cinnamic alcohol, and eugenol,

(B5) 2-(4-methyl-2-thiazolyl) ethanol,

(B6) ethyl-2-phenyl acetate,

(B7) (3-pentyloxan-4-yl) acetate,

(B8) phenylethyl dimethyl carbinyl acetate, and

(B9) methyl anthranilate; and

(C) 35% by mass or more and 86.95% by mass or less of water.

From the viewpoint of providing a repellent composition which is excellent in the repellent sustaining effect against a mosquito, is safe, is suppressed in the strong odor derived from the repellent component, and is excellent in a feeling of use, the composition of the present invention is preferably an oil-in-water type mosquito repellent composition or mosquito stay inhibition composition containing the following components (A) to (C), with a mass ratio [(A)/(B)] of the component (A) to the composition (B) being 10 or more and 400 or less, and having the content of other pest repellent than the component (A) and the component (B) of 15% by mass or less:

(A) 13% by mass or more and 50% by mass or less of at least one non-volatile liquid oily component selected from the group consisting of a silicone oil, an ester oil, an ether oil, a hydrocarbon oil, an aliphatic alcohol, and a polyhydric alcohol, the non-volatile liquid oily component having a surface tension at 25° C. of 40 mN/m or less and a viscosity at 23° C. as measured with a B-type rotational viscometer of 400 mPa·s or less;

(B) 0.05% by mass or more and 3.5% by mass or less of at least one fragrance selected from octahydro-2H-1-benzopyran-2-one and 7-hydroxy-3,7-dimethyloctanal; and

(C) 35% by mass or more and 86.95% by mass or less of water.

From the viewpoint of providing a repellent composition which is excellent in the repellent sustaining effect against a mosquito, is safe, is suppressed in the strong odor derived from the repellent component, and is excellent in a feeling of use, the composition of the present invention is preferably an oil-in-water type mosquito repellent composition or mosquito stay inhibition composition containing the following components (A) to (D), with a mass ratio [(A)/(B)] of the component (A) to the composition (B) being 10 or more and 400 or less, and having the content of other pest repellent than the component (A) and the component (B) of 15% by mass or less:

(A) 13% by mass or more and 50% by mass or less of at least one non-volatile liquid oily component selected from the group consisting of a silicone oil, an ester oil, and a hydrocarbon oil, the non-volatile liquid oily component having a surface tension at 25° C. of 40 mN/m or less and a viscosity at 23° C. as measured with a B-type rotational viscometer of 400 mPa·s or less;

(B) 0.05% by mass or more and 3.5% by mass or less of at least one fragrance selected from octahydro-2H-1-benzopyran-2-one and 7-hydroxy-3,7-dimethyloctanal;

(C) 35% by mass or more and 86.95% by mass or less of water; and

(D) 0.05% by mass or more and 3% by mass or less of a thickener.

The method for repelling pests of the present invention is a method in which even if a pest, such as a mosquito, lands on the target onto which the composition of the present invention has been applied or attached, the pest does not stay on that place, whereby the pest is repelled. Specifically, the method for repelling pests of the present invention has an effect of preventing a pest, such as a mosquito, from staying on the body surface of an animal, such a human, after landing thereon, for a time enough to pierce the animal, specifically, for example, 1 second or more. Such an effect is based on an unprecedented pest repellent principle and is safe without causing side effects, such as chopped skin.

Regarding the aforementioned embodiments, the present invention further discloses the following embodiments.

<1>

A pest repellent composition or pest stay inhibition composition containing the following components (A) and (B), with a mass ratio [(A)/(B)] of the component (A) to the composition (B) being 10 or more and 400 or less:

(A) 13% by mass or more and 99.95% by mass or less of at least one non-volatile liquid oily component selected from the group consisting of a silicone oil, an ester oil, an ether oil, a hydrocarbon oil, an aliphatic alcohol, and a polyhydric alcohol, the non-volatile liquid oily component having a surface tension at 25° C. of 40 mN/m or less and a viscosity at 23° C. as measured with a B-type rotational viscometer of 400 mPa·s or less; and

(B) 0.05% by mass or more and 3.5% by mass or less of at least one fragrance selected from the group consisting of the following (B1) to (B9):

(B1) at least one lactone selected from the group consisting of octahydro-2H-1-benzopyran-2-one, gamma decalactone, delta decalactone, delta nonalactone, and gamma undecalactone,

(B2) at least one ketone selected from the group consisting of 9-ethylidene-3-oxatricyclo[6.2.1.0^{2,7}]undecan-4-one and octahydro-7-methyl-1,4-methanonaphthalene-6(2H)-one,

(B3) at least one aldehyde selected from the group consisting of 7-hydroxy-3,7-dimethyloctanal and octahydro-5-methoxy-4,7-methano-1H-indene-2-carboxyaldehyde,

(B4) at least one aromatic alcohol selected from the group consisting of phenylethyl methyl ethyl carbinol, cinnamic alcohol, and eugenol,

(B5) 2-(4-methyl-2-thiazolyl) ethanol,

(B6) ethyl-2-phenyl acetate,

(B7) (3-pentyloxan-4-yl) acetate,

(B8) phenylethyl dimethyl carbinyl acetate, and

(B9) methyl anthranilate.

<2>

The composition as set forth in <1>, wherein the mass ratio [(A)/(B)] of the component (A) to the composition (B) is preferably 15 or more, more preferably 30 or more, and still more preferably 40 or more, and it is preferably 300 or less, more preferably 150 or less, still more preferably 120 or less, yet still more preferably 100 or less, and even yet still more preferably 70 or less.

<3>

The composition as set forth in <1> or <2>, the content of other pest repellent than the component (A) and the component (B) is 15% by mass or less, preferably 10% by mass or less, more preferably 5% by mass or less, still more preferably 4% by mass or less, yet still more preferably 3% by mass or less, and even yet still more preferably 1% by mass or less.

<4>

The composition as set forth in <3>, wherein the other pest repellent than the component (A) and the component (B) is at least one selected from the group consisting of DEET, Icaridin, dimethyl phthalate, 2-ethyl-1,3-hexanediol, p-menthane-3,8-diol, karan-3,4-diol, di-n-butyl succinate, hydroxyanisole, rotenone, ethyl 3-(acetylbutyl)aminopropionate, citronellol, eucalyptol, α-pinene, geraniol, citronellal, camphor, linalool, 2-undecanone, citronella oil, and lemongrass oil.

<5>

The composition as set forth in any one of <1> to <4>, wherein the surface tension at 25° C. of the component (A) is 15 mN/m or more, and preferably 17 mN/m or more, and it is preferably 30 mN/m or less, more preferably 28 mN/m or less, still more preferably 25 mN/m or less, yet still more preferably 23 mN/m or less, and even yet still more preferably 21 mN/m or less.

<6>

The composition as set forth in any one of <1> to <5>, wherein the viscosity at 23° C. of the component (A) as measured with a B-type rotational viscometer is 1 mPa·s or more, and it is preferably 300 mPa·s or less, more preferably 210 mPa·s or less, still more preferably 100 mPa·s or less, yet still more preferably 60 mPa·s or less, even yet still more preferably 40 mPa·s or less, even still more preferably 30 mPa·s or less.

<7>

The composition as set forth in any one of <1> to <6>, wherein the component (A) is at least one selected from the group consisting of a silicone oil, an ester oil, an ether oil, and a hydrocarbon oil, preferably at least one selected from the group consisting of a silicone oil, an ester oil, and a hydrocarbon oil, more preferably at least one selected from the group consisting of a silicone oil and an ester oil, and still more preferably a silicone oil.

<8>

The composition as set forth in any one of <1> to <7>, wherein the content of the component (A) is preferably 20% by mass or more, and more preferably 25% by mass or more, and it is preferably 80% by mass or less, more preferably 50% by mass or less, still more preferably 40% by mass or less, and yet still more preferably 35% by mass or less.

<9>

The composition as set forth in any one of <1> to <8>, wherein the component (B) is preferably at least one selected from the group consisting of octahydro-2H-1-benzopyran-2-one, gamma decalactone, gamma undecalactone, 9-ethylidene-3-oxatricyclo[6.2.1.0^{2,7}]undecan-4-one, octahydro-7-methyl-1,4-methanonaphthalene-6(2H)-one, 7-hydroxy-3,7-dimethyloctanal, octahydro-5-methoxy-4,7-methano-1H-indene-2-carboxyaldehyde, phenylethyl methyl ethyl carbinol, eugenol, 2-(4-methyl-2-thiazolyl) ethanol, (3-pentyloxan-4-yl) acetate, and methyl anthranilate; more preferably at least one selected from the group consisting of octahydro-2H-1-benzopyran-2-one and 7-hydroxy-3,7-dimethyloctanal; and still more preferably octahydro-2H-1-benzopyran-2-one.

<10>

The composition as set forth in any one of <1> to <9>, wherein the content of the component (B) in the composition is preferably 0.1% by mass or more, more preferably 0.2% by mass or more, and still more preferably 0.3% by mass or more, and it is preferably 2.5% by mass or less, more preferably 2.0% by mass or less, still more preferably 1.0% by mass or less, and yet still more preferably 0.7% by mass or less.

<11>

The composition as set forth in any one of <1> to <10>, containing water as a component (C).

<12>

The composition as set forth in <11>, wherein the content of the component (C) is 5% by mass or more, preferably 10% by mass or more, more preferably 35% by mass or more, and still more preferably 50% by mass or more, and it is 86.95% by mass or less, preferably 85% by mass or less, more preferably 80% by mass or less, and still more preferably 75% by mass or less.

<13>

The composition as set forth in <11> or <12>, wherein the composition is an oil-in-water type composition, and the content of the component (C) in the composition is preferably 35% by mass or more, more preferably 40% by mass or more, and still more preferably 50% by mass or more, and it is preferably 86.95% by mass or less, more preferably 80% by mass or less, and still more preferably 75% by mass or less.

<14>

The composition as set forth in <11> or <12>, wherein the composition is a water-in-oil type composition, and the content of the component (C) in the composition is preferably 5% by mass or more, more preferably 10% by mass or more, and still more preferably 15% by mass or more, and it is 40% by mass or less, preferably 30% by mass or less, and more preferably 25% by mass or less.

<15>

The composition as set forth in any one of <11> to <14>, wherein a mass ratio [(A)/(C)] of the component (A) to the component (C) is preferably 0.05 or more, more preferably 0.1 or more, still more preferably 0.15 or more, and yet still more preferably 0.3 or more, and it is preferably 10 or less, more preferably 3 or less, still more preferably 1 or less, and yet still more preferably 0.7 or less.

<16>

The composition as set forth in any one of <1> to <15>, further containing a thickener as a component (D) in an amount of preferably 0.01% by mass or more, more preferably 0.05% by mass or more, and still more preferably 0.1% by mass or more, and preferably 5% by mass or less, more preferably 3% by mass or less, and still more preferably 1% by mass or less.

<17>

An oil-in-water type mosquito repellent composition or mosquito stay inhibition composition containing the following components (A) to (C) and having the content of other pest repellent than the component (A) and the component (B) of 15% by mass or less:

(A) 13% by mass or more and 50% by mass or less of at least one non-volatile liquid oily component selected from the group consisting of a silicone oil, an ester oil, an ether oil, a hydrocarbon oil, an aliphatic alcohol, and a polyhydric alcohol, the non-volatile liquid oily component having a surface tension at 25° C. of 40 mN/m or less and a viscosity at 23° C. as measured with a B-type rotational viscometer of 400 mPa·s or less;

(B) 0.05% by mass or more and 3.5% by mass or less of at least one fragrance selected from the group consisting of the following (B1) to (B9):

(B1) at least one lactone selected from the group consisting of octahydro-2H-1-benzopyran-2-one, gamma decalactone, delta decalactone, delta nonalactone, and gamma undecalactone,

(B2) at least one ketone selected from the group consisting of 9-ethylidene-3-oxatricyclo[6.2.1.0^{2,7}]undecan-4-one and octahydro-7-methyl-1,4-methanonaphthalene-6(2H)-one,

(B3) at least one aldehyde selected from the group consisting of 7-hydroxy-3,7-dimethyloctanal and octahydro-5-methoxy-4,7-methano-1H-indene-2-carboxyaldehyde,

(B4) at least one aromatic alcohol selected from the group consisting of phenylethyl methyl ethyl carbinol, cinnamic alcohol, and eugenol,

(B5) 2-(4-methyl-2-thiazolyl) ethanol,

(B6) ethyl-2-phenyl acetate,

(B7) (3-pentyloxan-4-yl) acetate,

(B8) phenylethyl dimethyl carbinyl acetate, and

(B9) methyl anthranilate; and

(C) 35% by mass or more and 86.95% by mass or less of water.

<18>

An oil-in-water type mosquito repellent composition or mosquito stay inhibition composition containing the following components (A) to (C), with a mass ratio [(A)/(B)] of the component (A) to the composition (B) being 10 or more and 400 or less, and having the content of other pest repellent than the component (A) and the component (B) of 15% by mass or less:

(A) 13% by mass or more and 50% by mass or less of at least one non-volatile liquid oily component selected from the group consisting of a silicone oil, an ester oil, an ether oil, a hydrocarbon oil, an aliphatic alcohol, and a polyhydric alcohol, the non-volatile liquid oily component having a surface tension at 25° C. of 40 mN/m or less and a viscosity at 23° C. as measured with a B-type rotational viscometer of 400 mPa·s or less;

(B) 0.05% by mass or more and 3.5% by mass or less of at least one fragrance selected from the group consisting of the following (B1) to (B9):

(B1) at least one lactone selected from the group consisting of octahydro-2H-1-benzopyran-2-one, gamma decalactone, delta decalactone, delta nonalactone, and gamma undecalactone,

(B2) at least one ketone selected from the group consisting of 9-ethylidene-3-oxatricyclo[6.2.1.0^{2,7}]undecan-4-one and octahydro-7-methyl-1,4-methanonaphthalene-6(2H)-one,

(B3) at least one aldehyde selected from the group consisting of 7-hydroxy-3,7-dimethyloctanal and octahydro-5-methoxy-4,7-methano-1H-indene-2-carboxyaldehyde,

(B4) at least one aromatic alcohol selected from the group consisting of phenylethyl methyl ethyl carbinol, cinnamic alcohol, and eugenol,

(B5) 2-(4-methyl-2-thiazolyl) ethanol,

(B6) ethyl-2-phenyl acetate,

(B7) (3-pentyloxan-4-yl) acetate,

(B8) phenylethyl dimethyl carbinyl acetate, and

(B9) methyl anthranilate; and

(C) 35% by mass or more and 86.95% by mass or less of water.

<19>

An oil-in-water type mosquito repellent composition or mosquito stay inhibition composition containing the following components (A) to (C), with a mass ratio [(A)/(B)] of the component (A) to the composition (B) being 10 or more and 400 or less, and having the content of other pest repellent than the component (A) and the component (B) of 15% by mass or less:

(A) 13% by mass or more and 50% by mass or less of at least one non-volatile liquid oily component selected from the group consisting of a silicone oil, an ester oil, an ether oil, a hydrocarbon oil, an aliphatic alcohol, and a polyhydric alcohol, the non-volatile liquid oily component having a surface tension at 25° C. of 40 mN/m or less and a viscosity at 23° C. as measured with a B-type rotational viscometer of 400 mPa·s or less;

(B) 0.05% by mass or more and 3.5% by mass or less of at least one fragrance selected from octahydro-2H-1-benzopyran-2-one and 7-hydroxy-3,7-dimethyloctanal; and

(C) 35% by mass or more and 86.95% by mass or less of water.

<20>

An oil-in-water type mosquito repellent composition or mosquito stay inhibition composition containing the following components (A) to (D), with a mass ratio [(A)/(B)] of the component (A) to the composition (B) being 10 or more and 400 or less, and having the content of other pest repellent than the component (A) and the component (B) of 15% by mass or less:

(A) 13% by mass or more and 50% by mass or less of at least one non-volatile liquid oily component selected from the group consisting of a silicone oil, an ester oil, and a hydrocarbon oil, the non-volatile liquid oily component having a surface tension at 25° C. of 40 mN/m or less and a viscosity at 23° C. as measured with a B-type rotational viscometer of 400 mPa·s or less;

(B) 0.05% by mass or more and 3.5% by mass or less of at least one fragrance selected from octahydro-2H-1-benzopyran-2-one and 7-hydroxy-3,7-dimethyloctanal;

(C) 35% by mass or more and 86.95% by mass or less of water; and

(D) 0.05% by mass or more and 3% by mass or less of a thickener.

<21>

The composition as set forth in any one of <17> to <20>, wherein the other pest repellent than the component (A) and the component (B) is at least one selected from the group consisting of DEET, Icaridin, dimethyl phthalate, 2-ethyl-1,3-hexanediol, p-menthane-3,8-diol, karan-3,4-diol, di-n-butyl succinate, hydroxyanisole, rotenone, ethyl 3-(acetylbutyl)aminopropionate, citronellol, eucalyptol, α-pinene, geraniol, citronellal, camphor, linalool, 2-undecanone, citronella oil, and lemongrass oil.

<22>

A method for repelling pests, including applying the composition as set forth in any one of <1> to <21> onto the skin surface of a human.

<22>

A method for inhibiting pest stay, including attaching the composition as set forth in any one of <1> to <21> onto limbs of a pest to prevent the pest from staying on the skin of a human.

### EXAMPLES

The present invention is hereunder described by reference to Examples, but the present invention is not limited to the scope of the Examples. In the present Examples, various measurements and evaluations were performed by the following methods.

### (Surface Tension of Liquid Oily Component)

The surface tension of liquid oily component is a surface tension measured in an environment at 25° C. by the Wilhelmy method using a platinum plate, using an automatic surface tensiometer: Tensiometer K100 (manufactured by KRUSS GmbH).

### (Viscosity of Liquid Oily Component)

Viscometer TVB-10, manufactured by Toki Sangyo Co., Ltd. was used as a B-type rotational viscometer according to JIS K7117-1:1999. As to components to be measured, a viscosity value greatly differs for every sample, and therefore, it is difficult to accurately measure all components under a single measurement condition. Then, the measurement was performed using two types of rotors. The viscosity was first measured at a rotational speed of 12 rpm using a rotor M2 in an environment at 23° C. At this time, the component having a viscosity of 2,500 mPa·s or more was again measured at a rotational speed of 6 rpm, to obtain the viscosity value.

On the other hand, the component having a viscosity of 20 mPa·s or less was again measured at a rotational speed of 30 rpm using an L adapter that is a rotor for low viscosity in an environment of 23° C., to obtain the viscosity value.

### (Evaluation of Repellent Sustaining Effect Against Pests)

(I) Preparation of Aedes albopictus

As the Aedes albopictus, imagoes grown by breeding eggs of Aedes albopictus provided from Sumitomo Technoservice Co., Ltd. in a cage under a condition at 27° C. and a relative humidity (RH) of 60% were used.

A transparent plastic pan was filled with water in a depth of about 1 cm, and a filter paper having the purchased eggs laid thereon was put therein, thereby hatching the eggs into pupae. Thereafter, the hatched pupae were fed with a bait (tetramine) for tropical fish as a food for larvae every day. One week later, the pupae were collected with a dropper, transferred into a 20-mL plastic cup, which was then transferred into a net-spread cage. The pupae were fed with 10% by mass of sucrose contained in a 25-mL plastic tube as an adult food. After emergence, males and females were bred in the same cage for 5 days for mating. After 5 days of breeding, adult worms were collected using a fluke tube, the males and the females were visually separated after anesthesia for 5 minutes on ice, and only the females were collected and used for evaluation.

(II) Measurement of Repellent Sustaining Effect (Repellent Rate after Applying the Composition for 3 Hours)

200 females of Aedes albopictus were transferred into a mesh cage (30×30×30 cm), and the test was carried out at 27° C. and 60 RH %. For the repellent test, a model skin Bio Skin Plate (manufactured by Beaulax Co., Ltd., 4.5 cm×4.5 cm) reproducing the surface of the skin, which was warmed to 40° C. with a heater, was used, and the mesh cage was provided with an opening of 4.5 cm×4.5 cm, so as to allow the mosquitoes to land directly on the model skin.

The mosquito repellent rate was calculated as follows.

### (1) Calculation of Control Landing Number

The aforementioned warmed model skin (not applied with the composition) was put on the mesh cage containing the mosquitoes and activated by breathing for 5 seconds. Thereafter, the number of mosquitoes landed on the model skin was measured every 10 seconds for 2 minutes, and an average number thereof was defined as the landing number of 1.

(2) Calculation of Repellent Rate after Applying the Composition for 3 Hours

Subsequently, 2 mg/cm² of the composition targeted to the test was applied onto the model skin. After a lapse of 3 hours, the model skin was put on the mesh cage in the same manner and activated by breathing for 5 seconds. Thereafter, the number of mosquitoes landed on the model skin was measured every 10 seconds for 2 minutes, and an average number thereof was defined as the landing number of 2.

The repellent rate after applying the composition for 3 hours in each of the Examples was calculated according to the following equation while using the aforementioned landing numbers 1 and 2.

Repellent rate=[({Landing number 1)−(Landing number 2)}/(Landing number 1)×100(%)]

### (Evaluation of Odor Intensity)

On the surface of 4.5×4.5 cm of an inner part of a human forearm, the composition of each of the Examples was applied at a coverage of 2 mg/cm², followed by allowing to stand for 3 hours. Then, the odor intensity was determined by sensory evaluation by three evaluators. The odor intensity was evaluated on 6 grades (5: intense odor, 4: strong odor, 3: odor that can be easily perceived, 2: weak odor that indicates what odor it is, 1: barely perceptible odor, 0: odorless), and the average value of the evaluations by the three evaluators was taken as the odor intensity. The odor intensity suitable for skin application was classified as follows. It is expressed that the smaller the numerical value, the less the odor is, indicating that the composition is excellent.

A: 2.5 or less

B: More than 2.5 and 3.5 or less

C: More than 3.5

### (Evaluation of Long-Term Storage Stability)

80 mL of the composition of each of the Examples was placed in a 100-mL glass bottle, sealed, and then stored at 50° C. for 1 month. Thereafter, the presence or absence of separation of an oil phase in the composition was confirmed through visual inspection and expressed according to the following criteria.

A: Not changed

B: The oil phase coalesces, and some exudation from the emulsion to the surface can be seen.

C: Separation of the oil phase is observed.

### Examples 1 to 39 and Comparative Examples 1 to 24 (Production and Evaluation of Composition)

Respective components shown in Table 1 were blended in blending amounts shown in Tables 2 to 7, and an oil-in-water type composition of each of the Examples was obtained through a step of stirring at 8,000 rpm for 2 minutes by using an apparatus in which a stirring unit of a T.K. ROBOMIX (manufactured by Tokushu Kika Kogyo Co., Ltd.) was replaced by a T.K. homomixer MARKII 2.5 type. The expressions (A) to (D) listed in the tables are corresponding to the components (A) to (D) in this specification, respectively, and the expression (a) is corresponding to the liquid oily component falling outside the scope of the component (A) in this specification. In addition, the blending amounts shown in Tables 2 to 7 are the active ingredient amounts (% by mass) of the respective components. The various evaluations were performed by the aforementioned methods by using the obtained compositions. The results are shown in Tables 2 to 7.

TABLE 1

| | | | | | Surface | Viscosity |
|---|---|---|---|---|---|---|
| | | | | | tension at 25° C. | at 23° C. |
| Classification | | Trade name | Component name (common name) | Manufacturer | [mN/m] | [mPa · s] |
| (A1) | | Silicone KF-96A-6cs | Dimethylpolysiloxane | Shin-Etsu Chemical Co., Ltd. | 19.0 | 5 |
| (A2) | | Exceparl IPM | Isopropyl myristate | Kao Corporation | 28.0 | 5 |
| (A3) | | Nikkol Squalane | Squalane | Nippon Surfactant Industries | 30.0 | 42 |
| | | | | Co., Ltd. | | |
| (a1) | | Silicone KF-96-500cs | Dimethylpolysiloxane | Shin-Etsu Chemical Co., Ltd. | 21.0 | 560 |
| (a2) | | ZEMEA Propanediol | Propanediol | DuPont Tate & Lyle Bio | 48.0 | 53 |
| | | | | Products, LLC | | |
| (a3) | | Glycerin | Glycerin | FUJIFILM Wako Pure Chemical | 65.0 | 950 |
| | | | | Corporation | | |
| (a4) | | Silicone KF-96-5000cs | Dimethylpolysiloxane | Shin-Etsu Chemical Co., Ltd. | 21.0 | 4500 |
| Lactone (B1) | | OCTAHYDRO- | Octahydro-2H-1-benzopyran-2-one | INTERNATIONAL | — | — |
| | | COUMARIN | (Octahydrocoumarin) | FLAVOR AND FRAGRANCE | | |
| | | _{Υ}-Decalactone | 5-Hexyldihydrofuran-2(3H)-one | Kao Corporation- | — | — |
| | | | (_{Υ}-decalactone) | | | |
| | | δ-Decalactone | 6-Pentyltetrahydro-2H-pyran-2-one | Soda Aromatic Co., Ltd. | — | — |
| | | | (δ-decalactone) | | | |
| | | δ-Nonalactone | 6-Butyltetrahydro-2H-pyran-2-one | Soda Aromatic Co., Ltd. | — | — |
| | | | (δ-nonalactone) | | | |
| | | _{Υ}-Undecalactone | 5-Heptyldihydrofuran-2(3H)-one | Kao Corporation | — | — |
| | | | (Aldehyde C-14 peach, _{Υ}-undecalactone) | | | |
| Ketone (B2) | | FLOREX | 9-Ethylidene-3- | FIRMENICH | — | — |
| | | | oxatricyclo[6.2.1.0^{2.7}]undecane-4-one | | | |
| | | PLICATON | Octahydro-7-methyl-1,4- | FIRMENICH | — | — |
| | | | methanonaphthalen-6(2H)-one | | | |
| Aldehyde (B3) | | HYDROXY- | 7-Hydroxy-3,7-dimethyloctanal | BASF SE | — | — |
| | | CITRONELLAL | (Hydroxycitronellal) | | | |
| | | SCENTENAL | Octahydro-5-methoxy-4,7-methano- | FIRMENICH | — | — |
| | | | 1H-indene-2-carboxaldehyde | | | |
| Aromatic | | PHENYL ETHYL | 3-Methyl-1-phenyl-3-pentanol (Phenyl | INTERNATIONAL | — | — |
| alcohol (B4) | | METHYL ETHYL | Ethyl Methyl Ethyl Carbinol) | FLAVOR AND FRAGRANCE | | |
| | | CARBINOL | | | | |
| | | CINNAMIC ALCOHOL | 3-Phenylprop-2-en-1-ol | SYMRISE | — | — |
| | | | (Cinnamic Alcohol) | | | |
| | | EUGENOL | 4-Allyl-2-methoxyphenol (Eugenol) | Tokyo chemical Industry | — | — |
| | | | | Co., Ltd. | | |
| Other | (B5) | SULFUROL | 2-(4-Methyl-2-thiazolyl)ethanol | ALDRICH | — | — |
| component | (B6) | ETHYL PHENYL | Ethy1-2-phenylacetate | Tokyo chemical Industry | — | — |
| | | ACETATE | | Co., Ltd. | | |
| | (B7) | JASMONYL | (3-Pentyloxan-4-yl) acetate | GIVAUDAN | — | — |
| | (B8) | PHENYL ETHYL | (2-Methyl-1-phenylpropan-2-yl) acetate | INTERNATIONAL | — | — |
| | | DIMETHYL CARBINYL | (Phenyl Ethyl Dimethyl | FLAVOR AND FRAGRANCE | | |
| | | ACETATE | Carbinyl Acetate) | | | |
| | (B9) | Methyl Anthranilate | Methyl 2-aminobenzoate (Methyl | Tokyo chemical Industry | — | — |
| | | | Anthranilate) | Co., Ltd. | | |

| | | | | | |
|---|---|---|---|---|---|
| (D1) | ARISTOFLEX HMB | (Acryloyl dimethyl taurine ammonium/ | Clariant Iberica Production S.A. | — | — |
| | | beheneth-25 methacrylate) cross polymer | | | |
| (D2) | PEMULEN TR-1 | (Acrylate/alkyl acrylate (C10 to C30)) | Lubrizol Advanced Materials, | — | — |
| | | cross polymer | Inc. | | |
| (D3) | PEMULEN TR-2 | (Acrylate/alkyl acrylate (C10 to C30)) | Lubrizol Advanced Materials, | — | — |
| | | cross polymer | Inc. | | |

TABLE 2

| | | | Example | | | | | | | | | | | | | | | | |
|---|---|---|---|---|---|---|---|---|---|---|---|---|---|---|---|---|---|---|---|
| % by mass | | | 1 | 2 | 3 | 4 | 5 | 6 | 7 | 8 | 9 | 10 | 11 | 12 | 13 | 14 | 15 | 16 | 17 |
| (A1) | Silicone KF- | Dimethylpolysiloxane | 30.00 | 30.00 | 30.00 | 30.00 | 30.00 | 30.00 | 30.00 | 30.00 | 30.00 | 30.00 | 30.00 | 30.00 | 30.00 | 30.00 | 30.00 | 30.00 | 30.00 |
| | 96A-6cs | | | | | | | | | | | | | | | | | | |
| (B1) | OCTAHYDRO- | Octahydro-2H-1- | 0.50 | | | | | | | | | | | | | | | | |
| | COUMARIN | benzopyran-2-one | | | | | | | | | | | | | | | | | |
| | | (Octahydrocoumarin) | | | | | | | | | | | | | | | | | |
| | _{Υ}-Decalactone | 5-Hexyldihydrofuran- | | 0.50 | | | | | | | | | | | | | | | |
| | | 2(3H)-one | | | | | | | | | | | | | | | | | |
| | | (_{Υ}-decalactone) | | | | | | | | | | | | | | | | | |
| | δ-Decalactone | 6-Pentyltetrahydro- | | | 0.50 | | | | | | | | | | | | | | |
| | | 2H-pyran-2- | | | | | | | | | | | | | | | | | |
| | | one (δ-decalactone) | | | | | | | | | | | | | | | | | |
| | δ-Nonalactone | 6-Butyltetrahydro- | | | | 0.50 | | | | | | | | | | | | | |
| | | 2H-pyran-2- | | | | | | | | | | | | | | | | | |
| | | one (δ-nonalactone) | | | | | | | | | | | | | | | | | |
| | _{Υ}-Undecalactone | 5-Heptyldihydrofuran- | | | | | 0.50 | | | | | | | | | | | | |
| | | 2(3H)-one (Aldehyde | | | | | | | | | | | | | | | | | |
| | | C-14 peach, | | | | | | | | | | | | | | | | | |
| | | _{Υ}-undecalactone) | | | | | | | | | | | | | | | | | |
| (B2) | FLOREX | 9-Ethylidene-3- | | | | | | 0.50 | | | | | | | | | | | |
| | | oxatri-cyclo[6.2.1.0^{2.7}] | | | | | | | | | | | | | | | | | |
| | | undecane-4-one | | | | | | | | | | | | | | | | | |
| | PLICATON | Octahydro-7-methyl-1,4- | | | | | | | 0.50 | | | | | | | | | | |
| | | methanonaphthalen- | | | | | | | | | | | | | | | | | |
| | | 6(2H)-one | | | | | | | | | | | | | | | | | |
| (B3) | HYDROXY- | 7-Hydroxy- | | | | | | | | 0.50 | | | | | | | | | |
| | CITRONELLAL | 3,7-dimethyloctanal | | | | | | | | | | | | | | | | | |
| | | (Hydroxycitronellal) | | | | | | | | | | | | | | | | | |
| | SCENTENAL | Octahydro-5-methoxy- | | | | | | | | | 0.50 | | | | | | | | |
| | | 4,7-methano-1H-indene- | | | | | | | | | | | | | | | | | |
| | | 2-carboxaldehyde | | | | | | | | | | | | | | | | | |
| (B4) | PHENYL | 3-Methyl-1- | | | | | | | | | | 0.50 | | | | | | | |
| | ETHYL | phenyl-3-pentanol | | | | | | | | | | | | | | | | | |
| | METHYL | (Phenyl Ethyl | | | | | | | | | | | | | | | | | |
| | ETHYL | Methyl Ethyl Carbinol) | | | | | | | | | | | | | | | | | |
| | CARBINOL | | | | | | | | | | | | | | | | | | |
| | CINNAMIC | 3-Phenylprop-2-en-1-ol | | | | | | | | | | | 0.50 | | | | | | |
| | ALCOHOL | (Cinnamic Alcohol) | | | | | | | | | | | | | | | | | |
| | EUGENOL | 4-Allyl-2- | | | | | | | | | | | | 0.50 | | | | | |
| | | methoxyphenol | | | | | | | | | | | | | | | | | |
| | | (Eugenol) | | | | | | | | | | | | | | | | | |
| (B5) | SULFUROL | 2-(4-Methyl-2- | | | | | | | | | | | | | 0.50 | | | | |
| | | thiazolyl)ethanol | | | | | | | | | | | | | | | | | |
| (B6) | ETHYL | Ethyl-2-phenylacetate | | | | | | | | | | | | | | 0.50 | | | |
| | PHENYL | | | | | | | | | | | | | | | | | | |
| | ACETATE | | | | | | | | | | | | | | | | | | |
| (B7) | JASMONYL | (3-Pentyloxan-4-yl) | | | | | | | | | | | | | | | 0.50 | | |
| | | acetate | | | | | | | | | | | | | | | | | |
| (B8) | PHENYL | (2-Methyl-1- | | | | | | | | | | | | | | | | 0.50 | |
| | ETHYL | phenylpropan-2-yl) | | | | | | | | | | | | | | | | | |
| | DIMETHYL | acetate (Phenyl Ethyl | | | | | | | | | | | | | | | | | |
| | CARBINYL | Dimethyl | | | | | | | | | | | | | | | | | |
| | ACETATE | Carbinyl Acetate) | | | | | | | | | | | | | | | | | |
| (B9) | Methyl | Methyl 2-aminobenzoate | | | | | | | | | | | | | | | | | 0.50 |
| | Anthranilate | (Methyl Anthranilate) | | | | | | | | | | | | | | | | | |
| (D1) | ARISTOFLEX | (Acryloyl dimethyl | 0.50 | 0.50 | 0.50 | 0.50 | 0.50 | 0.50 | 0.50 | 0.50 | 0.50 | 0.50 | 0.50 | 0.50 | 0.50 | 0.50 | 0.50 | 0.50 | 0.50 |
| | HMB | taurine ammonium/ | | | | | | | | | | | | | | | | | |
| | | beheneth-25 | | | | | | | | | | | | | | | | | |
| | | methacrylate) cross | | | | | | | | | | | | | | | | | |
| | | polymer | | | | | | | | | | | | | | | | | |
| (C) | Ion exchanged water | | 69.00 | 69.00 | 69.00 | 69.00 | 69.00 | 69.00 | 69.00 | 69.00 | 69.00 | 69.00 | 69.00 | 69.00 | 69.00 | 69.00 | 69.00 | 69.00 | 69.00 |
| Total | | | 100.00 | 100.00 | 100.00 | 100.00 | 100.00 | 100.00 | 100.00 | 100.00 | 100.00 | 100.00 | 100.00 | 100.00 | 100.00 | 100.00 | 100.00 | 100.00 | 100.00 |
| Mass ratio (A)/(B) | | | 60 | 60 | 60 | 60 | 60 | 60 | 60 | 60 | 60 | 60 | 60 | 60 | 60 | 60 | 60 | 60 | 60 |
| Mass ratio (A)/(C) | | | 0.43 | 0.43 | 0.43 | 0.43 | 0.43 | 0.43 | 0.43 | 0.43 | 0.43 | 0.43 | 0.43 | 0.43 | 0.43 | 0.43 | 0.43 | 0.43 | 0.43 |
| Eval- | Repellent sustaining effect (Repellent | | 94 | 81 | 78 | 72 | 85 | 85 | 80 | 90 | 84 | 82 | 67 | 81 | 89 | 70 | 86 | 72 | 83 |
| uation | rate after applying for 3 hours (%)) | | | | | | | | | | | | | | | | | | |
| results | Odor intensity | Score | 2.7 | 3.0 | 3.0 | 3.3 | 3.0 | 2.7 | 2.7 | 2.7 | 2.7 | 2.7 | 3.3 | 3.0 | 3.3 | 3.3 | 2.7 | 2.7 | 3.0 |
| | | Judgement | B | B | B | B | B | B | B | B | B | B | B | B | B | B | B | B | B |
| | Long-term | Judgement | A | A | A | A | A | A | A | A | A | A | A | A | A | A | A | A | A |
| | storage stability | | | | | | | | | | | | | | | | | | |

TABLE 3

| | | | Comparative Example | | | | | | | | | | | | | | | | | |
|---|---|---|---|---|---|---|---|---|---|---|---|---|---|---|---|---|---|---|---|---|
| % by mass | | | 1 | 2 | 3 | 4 | 5 | 6 | 7 | 8 | 9 | 10 | 11 | 12 | 13 | 14 | 15 | 16 | 17 | 18 |
| (A1) | Silicone KF- | Dimethyl- | 30.00 | | | | | | | | | | | | | | | | | |
| | 96A-6cs | polysiloxane | | | | | | | | | | | | | | | | | | |
| (B1) | OCTA- | Octahydro- | | 0.50 | | | | | | | | | | | | | | | | |
| | HYDRO- | 2H-1- | | | | | | | | | | | | | | | | | | |
| | COUMARIN | benzopyran- | | | | | | | | | | | | | | | | | | |
| | | 2-one | | | | | | | | | | | | | | | | | | |
| | | (Octahydro- | | | | | | | | | | | | | | | | | | |
| | | coumarin) | | | | | | | | | | | | | | | | | | |
| | _{Υ}- | 5-Hexyl- | | | 0.50 | | | | | | | | | | | | | | | |
| | Decalactone | dihydrofuran- | | | | | | | | | | | | | | | | | | |
| | | 2(3H)-one | | | | | | | | | | | | | | | | | | |
| | | (_{Υ}-decalactone) | | | | | | | | | | | | | | | | | | |
| | δ- | 6-Pentyl- | | | | 0.50 | | | | | | | | | | | | | | |
| | Decalactone | tetrahydro- | | | | | | | | | | | | | | | | | | |
| | | 2H-pyran-2-one | | | | | | | | | | | | | | | | | | |
| | | (δ-decalactone) | | | | | | | | | | | | | | | | | | |
| | δ- | 6-Butyl- | | | | | 0.50 | | | | | | | | | | | | | |
| | Nonalactone | tetrahydro- | | | | | | | | | | | | | | | | | | |
| | | 2H-pyran-2-one | | | | | | | | | | | | | | | | | | |
| | | (δ-nonalactone) | | | | | | | | | | | | | | | | | | |
| | _{Υ}- | 5-Heptyl- | | | | | | 0.50 | | | | | | | | | | | | |
| | Undecalactone | dihydrofuran- | | | | | | | | | | | | | | | | | | |
| | | 2(3H)-one | | | | | | | | | | | | | | | | | | |
| | | (Aldehyde | | | | | | | | | | | | | | | | | | |
| | | C-14 peach, | | | | | | | | | | | | | | | | | | |
| | | _{Υ}-undecalactone) | | | | | | | | | | | | | | | | | | |
| (B2) | FLOREX | 9-Ethylidene-3- | | | | | | | 0.50 | | | | | | | | | | | |
| | | oxatricyclo | | | | | | | | | | | | | | | | | | |
| | | [6.2.1.0^{2.7}] | | | | | | | | | | | | | | | | | | |
| | | undecane-4-one | | | | | | | | | | | | | | | | | | |
| | PLICATON | Octahydro- | | | | | | | | 0.50 | | | | | | | | | | |
| | | 7-methyl-1,4- | | | | | | | | | | | | | | | | | | |
| | | methano- | | | | | | | | | | | | | | | | | | |
| | | naphthalen- | | | | | | | | | | | | | | | | | | |
| | | 6(2H)-one | | | | | | | | | | | | | | | | | | |
| (B3) | HYDROXY- | 7-Hydroxy-3,7- | | | | | | | | | 0.50 | | | | | | | | | |
| | CITRO- | dimethyloctanal | | | | | | | | | | | | | | | | | | |
| | NELLAL | (Hydroxy- | | | | | | | | | | | | | | | | | | |
| | | citronellal) | | | | | | | | | | | | | | | | | | |
| | SCENTENAL | Octahydro-5- | | | | | | | | | | 0 50 | | | | | | | | |
| | | methoxy-4,7- | | | | | | | | | | | | | | | | | | |
| | | methano- | | | | | | | | | | | | | | | | | | |
| | | 1H-indene-2- | | | | | | | | | | | | | | | | | | |
| | | carboxaldehyde | | | | | | | | | | | | | | | | | | |
| | | FIRMENICH | | | | | | | | | | | | | | | | | | |
| (B4) | PHENYL | 3-Methyl- | | | | | | | | | | | 0.50 | | | | | | | |
| | ETHYL | 1-phenyl- | | | | | | | | | | | | | | | | | | |
| | METHYL | 3-pentanol | | | | | | | | | | | | | | | | | | |
| | ETHYL | (Phenyl Ethyl | | | | | | | | | | | | | | | | | | |
| | CARBINOL | Methyl | | | | | | | | | | | | | | | | | | |
| | | Ethyl Carbinol) | | | | | | | | | | | | | | | | | | |
| | CINNAMIC | 3-Phenylprop- | | | | | | | | | | | | 0.50 | | | | | | |
| | ALCOHOL | 2-en-1-ol | | | | | | | | | | | | | | | | | | |
| | | (Cinnamic | | | | | | | | | | | | | | | | | | |
| | | Alcohol) | | | | | | | | | | | | | | | | | | |
| | EUGENOL | 4-Allyl-2- | | | | | | | | | | | | | 0.50 | | | | | |
| | | methoxyphenol | | | | | | | | | | | | | | | | | | |
| | | (Eugenol) | | | | | | | | | | | | | | | | | | |
| (B5) | SULFUROL | 2-(4-Methyl- | | | | | | | | | | | | | | 0.50 | | | | |
| | | 2-thiazolyl) | | | | | | | | | | | | | | | | | | |
| | | ethanol | | | | | | | | | | | | | | | | | | |
| (B6) | ETHYL | Ethyl-2- | | | | | | | | | | | | | | | 0.50 | | | |
| | PHENYL | phenylacetate | | | | | | | | | | | | | | | | | | |
| | ACETATE | | | | | | | | | | | | | | | | | | | |
| (B7) | JASMONYL | (3-Pentyloxan- | | | | | | | | | | | | | | | | 0.50 | | |
| | | 4-yl) acetate | | | | | | | | | | | | | | | | | | |
| (B8) | PHENYL | (2-Methyl-1- | | | | | | | | | | | | | | | | | 0.50 | |
| | ETHYL | phenylpropan- | | | | | | | | | | | | | | | | | | |
| | DIMETHYL | 2-yl) acetate | | | | | | | | | | | | | | | | | | |
| | CARBINYL | (Phenyl | | | | | | | | | | | | | | | | | | |
| | ACETATE | Ethyl | | | | | | | | | | | | | | | | | | |
| | | Dimethyl | | | | | | | | | | | | | | | | | | |
| | | Carbinyl | | | | | | | | | | | | | | | | | | |
| | | Acetate) | | | | | | | | | | | | | | | | | | |
| (B9) | Methyl | Methyl 2- | | | | | | | | | | | | | | | | | | 0.50 |
| | Anthranilate | aminobenzoate | | | | | | | | | | | | | | | | | | |
| | | (Methyl | | | | | | | | | | | | | | | | | | |
| | | Anthranilate) | | | | | | | | | | | | | | | | | | |
| (D1) | ARISTO- | (Acryloyl | 0.50 | 0.50 | 0.50 | 0.50 | 0.50 | 0.50 | 0.50 | 0.50 | 0.50 | 0.50 | 0.50 | 0.50 | 0.50 | 0.50 | 0.50 | 0.50 | 0.50 | 0.50 |
| | FLEX | dimethyl | | | | | | | | | | | | | | | | | | |
| | HMB | taurine | | | | | | | | | | | | | | | | | | |
| | | ammonium/ | | | | | | | | | | | | | | | | | | |
| | | beheneth-25 | | | | | | | | | | | | | | | | | | |
| | | methacrylate) | | | | | | | | | | | | | | | | | | |
| | | cross | | | | | | | | | | | | | | | | | | |
| | | polymer | | | | | | | | | | | | | | | | | | |
| (C) | Ion exchanged water | | 69.50 | 99.00 | 99.00 | 99.00 | 99.00 | 99.00 | 99.00 | 99.00 | 99.00 | 99.00 | 99.00 | 99.00 | 99.00 | 99.00 | 99.00 | 99.00 | 99.00 | 99.00 |
| Total | | | 100.00 | 100.00 | 100.00 | 100.00 | 100.00 | 100.00 | 100.00 | 100.00 | 100.00 | 100.00 | 100.00 | 100.00 | 100.00 | 100.00 | 100.00 | 100.00 | 100.00 | 100.00 |
| Mass ratio (A)/(B) | | | — | 0 | 0 | 0 | 0 | 0 | 0 | 0 | 0 | 0 | 0 | 0 | 0 | 0 | 0 | 0 | 0 | 0 |
| Mass ratio (A)/(C) | | | 0.43 | 0 | 0 | 0 | 0 | 0 | 0 | 0 | 0 | 0 | 0 | 0 | 0 | 0 | 0 | 0 | 0 | 0 |
| Eval- | Repellent sustaining effect | | 50 | 16 | 6 | 0 | 0 | 10 | 8 | 0 | 5 | 0 | 0 | 0 | 0 | 12 | 0 | 7 | 0 | 10 |
| uation | (Repellent rate after | | | | | | | | | | | | | | | | | | | |
| results | applying for 3 hours (%)) | | | | | | | | | | | | | | | | | | | |
| | Odor intensity | Score | 0.7 | 2.7 | 3.0 | 3.0 | 3.3 | 3.0 | 2.7 | 2.7 | 2.7 | 2.7 | 2.7 | 3.3 | 3.0 | 3.3 | 3.3 | 2.7 | 2.7 | 3.0 |
| | | Judgement | A | B | B | B | B | B | B | B | B | B | B | B | B | B | B | B | B | B |
| | Long-term | Judgement | — | — | — | — | — | — | — | — | — | — | — | — | — | — | — | — | — | — |
| | storage | | | | | | | | | | | | | | | | | | | |
| | stability | | | | | | | | | | | | | | | | | | | |

TABLE 4

| | | | Example | | | | | | | Comparative Example | | | | |
|---|---|---|---|---|---|---|---|---|---|---|---|---|---|---|
| % by mass | | | 1 | 18 | 19 | 2 | 20 | 8 | 21 | 1 | 2 | 3 | 9 | 19 |
| (A1) | Silicone | Dimethyl- | 30.00 | 30.00 | 30.00 | 30.00 | 30.00 | 30.00 | 30.00 | 30.00 | | | | 30.00 |
| | KF- | poly- | | | | | | | | | | | | |
| | 96A-6cs | siloxane | | | | | | | | | | | | |
| (B1) | OCTA- | Octahydro- | 0.50 | 0.10 | 2.00 | | | | | | 0.50 | | | 10.00 |
| | HYDRO- | 2H-1- | | | | | | | | | | | | |
| | COU- | benzo- | | | | | | | | | | | | |
| | MARIN | pyran- | | | | | | | | | | | | |
| | | 2-one | | | | | | | | | | | | |
| | | (Octa- | | | | | | | | | | | | |
| | | hydro- | | | | | | | | | | | | |
| | | coumarin) | | | | | | | | | | | | |
| | _{Υ}- | 5-Hexyl- | | | | 0.50 | 0.10 | | | | | 0.50 | | |
| | Deca- | dihydro- | | | | | | | | | | | | |
| | lactone | furan- | | | | | | | | | | | | |
| | | 2(3H)-one | | | | | | | | | | | | |
| | | (_{Υ}- | | | | | | | | | | | | |
| | | Deca- | | | | | | | | | | | | |
| | | lactone) | | | | | | | | | | | | |
| (B3) | HY- | 7-Hydroxy- | | | | | | 0.50 | 0.10 | | | | 0.50 | |
| | DROXY- | 3,7- | | | | | | | | | | | | |
| | CITRO- | dimethyl- | | | | | | | | | | | | |
| | NELLAL | octanal | | | | | | | | | | | | |
| | | (Hydroxy- | | | | | | | | | | | | |
| | | citronellal) | | | | | | | | | | | | |
| (D1) | ARISTO- | (Acryloyl | 0.50 | 0.50 | 0.50 | 0.50 | 0.50 | 0.50 | 0.50 | 0.50 | 0.50 | 0.50 | 0.50 | 0.50 |
| | FLEX | dimethyl | | | | | | | | | | | | |
| | HMB | taurine | | | | | | | | | | | | |
| | | ammo- | | | | | | | | | | | | |
| | | nium/ | | | | | | | | | | | | |
| | | beheneth- | | | | | | | | | | | | |
| | | 25 | | | | | | | | | | | | |
| | | meth- | | | | | | | | | | | | |
| | | acrylate) | | | | | | | | | | | | |
| | | cross | | | | | | | | | | | | |
| | | polymer | | | | | | | | | | | | |
| (C) | Ion exchanged water | | 69.00 | 69.40 | 67.50 | 69.00 | 69.40 | 69.00 | 69.40 | 69.50 | 99.00 | 99.00 | 99.00 | 59.50 |
| Total | | | 100.00 | 100.00 | 100.00 | 100.00 | 100.00 | 100.00 | 100.00 | 100.00 | 100.00 | 100.00 | 100.00 | 100.00 |
| Mass ratio (A)/(B) | | | 60 | 300 | 15 | 60 | 300 | 60 | 300 | — | 0 | 0 | 0 | 3.0 |
| Mass ratio (A)/(C) | | | 0.43 | 0.43 | 0.44 | 0.43 | 0.43 | 0.43 | 0.43 | 0.43 | 0 | 0 | 0 | 0.50 |
| Eval- | Repellent sustaining | | 94 | 63 | 100 | 81 | 60 | 90 | 60 | 50 | 16 | 6 | 5 | 100 |
| uation | effect (Repellent rate | | | | | | | | | | | | | |
| results | after applying | | | | | | | | | | | | | |
| | for 3 hours (%)) | | | | | | | | | | | | | |
| | Odor | Score | 2.7 | 1.7 | 3.3 | 3.0 | 2.0 | 2.7 | 2.0 | 0.7 | 2.7 | 3.0 | 2.7 | 4.0 |
| | intensity | Judgement | B | A | B | B | A | B | A | A | B | B | B | C |
| | Long-term | Judgement | A | A | B | A | A | A | A | — | — | — | — | — |
| | storage | | | | | | | | | | | | | |
| | stability | | | | | | | | | | | | | |

TABLE 5

| | | | Example | | | | | |
|---|---|---|---|---|---|---|---|---|
| % by mass | | | 1 | 2 | 22 | 8 | 23 | 24 |
| (A1) | Silicone KF-96A-6cs | Dimethylpolysiloxane | 30.00 | 30.00 | 30.00 | 30.00 | 30.00 | 30.00 |
| (B1) | OCTAHYDROCOUMARIN | Octahydro-2H-1-benzopyran-2-one | 0.50 | | 0.10 | | 0.10 | 0.10 |
| | | (Octahydrocoumarin) | | | | | | |
| | _{Υ}-Decalactone | 5-Hexyldihydrofuran-2(3H)-one | | 0.50 | 0.10 | | | 0.10 |
| | | (_{Υ}-Decalactone) | | | | | | |
| (B3) | HYDROXYCITRONELLAL | 7-Hydroxy-3,7-dimethyloctanal | | | | 0.50 | 0.10 | 0.10 |
| | | (Hydroxycitronellal) | | | | | | |
| (D1) | ARISTOFLEX HMB | (Acryloyl dimethyl taurine | 0.50 | 0.50 | 0.50 | 0.50 | 0.50 | 0.50 |
| | | ammonium/beheneth-25 | | | | | | |
| | | methacrylate) cross polymer | | | | | | |
| (C) | Ion exchanged water | | 69.00 | 69.00 | 69.30 | 69.00 | 69.30 | 69.20 |
| Total | | | 100.00 | 100.00 | 100.00 | 100.00 | 100.00 | 100.00 |
| Mass ratio (A)/(B) | | | 60 | 60 | 150 | 60 | 150 | 100 |
| Mass ratio (A)/(C) | | | 0.43 | 0.43 | 0.43 | 0.43 | 0.43 | 0.43 |
| Evaluation | Repellent sustaining effect (Repellent rate after applying for 3 hours | | 94 | 81 | 67 | 90 | 70 | 90 |
| results | (%)) | | | | | | | |
| | Odor intensity | Score | 2.7 | 3.0 | 2.0 | 2.7 | 2.3 | 2.3 |
| | | Judgement | B | B | A | B | A | A |
| | Long-term storage stability | Judgement | A | A | A | A | A | A |

TABLE 6

| | | | Example | | | | | | | | | | | | |
|---|---|---|---|---|---|---|---|---|---|---|---|---|---|---|---|
| | | | 1 | 25 | 26 | 27 | 28 | 29 | 30 | 31 | 32 | 33 | 34 | 35 | 36 |
| (A1) | Silicone | Dimethyl- | 30.00 | 15.00 | 45.00 | 60.00 | | | | | | | 15.00 | 15.00 | |
| | KF-96A-6cs | polysiloxane | | | | | | | | | | | | | |
| (A2) | Exceparl | Isopropyl | | | | | 15.00 | 30.00 | 45.00 | | | | 15.00 | | 15.00 |
| | IPM | myristate | | | | | | | | | | | | | |
| (A3) | Nikkol | Squalane | | | | | | | | 15.00 | 30.00 | 45.00 | | 15.00 | 15.00 |
| | Squalane | | | | | | | | | | | | | | |
| (a1) | Silicone KF-96-500cs | Dimethyl- | | | | | | | | | | | | | |
| | | polysiloxane | | | | | | | | | | | | | |
| (a2) | ZEMEA | Propanediol | | | | | | | | | | | | | |
| | Propanediol | | | | | | | | | | | | | | |
| (a3) | Glycerin | Glycerin | | | | | | | | | | | | | |
| (a4) | Silicone | Dimethyl- | | | | | | | | | | | | | |
| | KF-96-5000cs | polysiloxane | | | | | | | | | | | | | |
| (B1) | OCTAHYDRO- | Octahydro- | 0.50 | 0.50 | 0.50 | 0.50 | 0.50 | 0.50 | 0.50 | 0.50 | 0.50 | 0.50 | 0.50 | 0.50 | 0.50 |
| | COUMARIN | 2H-1- | | | | | | | | | | | | | |
| | | benzopyran- | | | | | | | | | | | | | |
| | | 2-one | | | | | | | | | | | | | |
| | | (Octahydrocoumarin) | | | | | | | | | | | | | |
| (D1) | ARISTOFLEX | (Acryloyl | 0.50 | 0.50 | 0.50 | 0.50 | 0.50 | 0.50 | 0.50 | 0.50 | 0.50 | 0.50 | 0.50 | 0.50 | 0.50 |
| | HMB | dimethyl | | | | | | | | | | | | | |
| | | taurine | | | | | | | | | | | | | |
| | | ammonium/ | | | | | | | | | | | | | |
| | | beheneth- | | | | | | | | | | | | | |
| | | 25 methacrylate) | | | | | | | | | | | | | |
| | | cross | | | | | | | | | | | | | |
| | | polymer | | | | | | | | | | | | | |
| (C) | Ion exchanged water | | 69.00 | 84.00 | 54.00 | 39.00 | 84.00 | 69.00 | 54.00 | 84.00 | 69.00 | 54.00 | 69.00 | 69.00 | 69.00 |
| Total | | | 100.00 | 100.00 | 100.00 | 100.00 | 100.00 | 100.00 | 100.00 | 100.00 | 100.00 | 100.00 | 100.00 | 100.00 | 100.00 |
| Mass ratio (A)/(B) | | | 60 | 30 | 90 | 120 | 30 | 60 | 90 | 30 | 60 | 90 | 60 | 60 | 60 |
| Mass ratio (A)/(C) | | | 0.43 | 0.18 | 0.83 | 1.54 | 0.18 | 0.43 | 0.83 | 0.18 | 0.43 | 0.83 | 0.43 | 0.43 | 0.43 |
| Eval- | Repellent sustaining | | 94 | 70 | 99 | 100 | 62 | 78 | 85 | 60 | 73 | 83 | 75 | 70 | 66 |
| uation | effect (Repellent rate | | | | | | | | | | | | | | |
| results | after applying for | | | | | | | | | | | | | | |
| | 3 hours (%)) | | | | | | | | | | | | | | |
| | Odor | Score | 2.7 | 2.7 | 2.7 | 2.7 | 2.3 | 2.3 | 2.0 | 2.3 | 2.3 | 2.0 | 2.3 | 2.3 | 2.3 |
| | intensity | Judgement | B | B | B | B | A | A | A | A | A | A | A | A | A |
| | Long-term | Judgement | A | A | B | C | A | A | B | A | A | B | B | B | B |
| | storage | | | | | | | | | | | | | | |
| | stability | | | | | | | | | | | | | | |
| | | | | | | | | | Comparative Example | | | | | | |
| | | | | | | | | | 1 | 2 | 20 | 21 | 22 | 23 | 24 |
| | | | | | | (A1) | Silicone | Dimethyl- | 30.00 | | 10.00 | | | | |
| | | | | | | | KF-96A-6cs | polysiloxane | | | | | | | |
| | | | | | | (A2) | Exceparl | Isopropyl | | | | | | | |
| | | | | | | | IPM | myristate | | | | | | | |
| | | | | | | (A3) | Nikkol | Squalane | | | | | | | |
| | | | | | | | Squalane | | | | | | | | |
| | | | | | | (a1) | Silicone KF-96-500cs | Dimethyl- | | | | 30.00 | | | |
| | | | | | | | | polysiloxane | | | | | | | |
| | | | | | | (a2) | ZEMEA | Propanediol | | | | | 30.00 | | |
| | | | | | | | Propanediol | | | | | | | | |
| | | | | | | (a3) | Glycerin | Glycerin | | | | | | 30.00 | |
| | | | | | | (a4) | Silicone | Dimethyl- | | | | | | | 30.00 |
| | | | | | | | KF-96-5000cs | polysiloxane | | | | | | | |
| | | | | | | (B1) | OCTAHYDRO- | Octahydro- | | 0.50 | 0.50 | 0.50 | 0.50 | 0.50 | 0.50 |
| | | | | | | | COUMARIN | 2H-1- | | | | | | | |
| | | | | | | | | benzopyran- | | | | | | | |
| | | | | | | | | 2-one | | | | | | | |
| | | | | | | | | (Octahydrocoumarin) | | | | | | | |
| | | | | | | (D1) | ARISTOFLEX | (Acryloyl | 0.50 | 0.50 | 0.50 | 0.50 | 0.50 | 0.50 | 0.50 |
| | | | | | | | HMB | dimethyl | | | | | | | |
| | | | | | | | | taurine | | | | | | | |
| | | | | | | | | ammonium/ | | | | | | | |
| | | | | | | | | beheneth- | | | | | | | |
| | | | | | | | | 25 methacrylate) | | | | | | | |
| | | | | | | | | cross | | | | | | | |
| | | | | | | | | polymer | | | | | | | |
| | | | | | | (C) | Ion exchanged water | | 69.50 | 99.00 | 89.00 | 69.00 | 69.00 | 69.00 | 69.00 |
| | | | | | | Total | | | 100.00 | 100.00 | 100.00 | 100.00 | 100.00 | 100.00 | 100.00 |
| | | | | | | Mass ratio (A)/(B) | | | — | — | 20 | 0 | 0 | 0 | 0 |
| | | | | | | Mass ratio (A)/(C) | | | 0.43 | 0 | 0.11 | 0 | 0 | 0 | 0 |
| | | | | | | Eval- | Repellent sustaining | | 50 | 16 | 30 | 15 | 25 | 15 | 13 |
| | | | | | | uation | effect (Repellent rate | | | | | | | | |
| | | | | | | results | after applying for | | | | | | | | |
| | | | | | | | 3 hours (%)) | | | | | | | | |
| | | | | | | | Odor | Score | 0.7 | 2.7 | 2.7 | 2.7 | 2.7 | 2.7 | 2.7 |
| | | | | | | | intensity | Judgement | A | B | B | B | B | B | B |
| | | | | | | | Long-term | Judgement | — | — | — | — | — | — | — |
| | | | | | | | storage | | | | | | | | |
| | | | | | | | stability | | | | | | | | |

TABLE 7

| | | | Example | | | |
|---|---|---|---|---|---|---|
| | | | 1 | 37 | 38 | 39 |
| (A1) | Silicone KF-96A-6cs | Dimethylpolysiloxane | 30.00 | 30.00 | 30.00 | 30.00 |
| (B1) | OCTAHYDROCOUMARIN | Octahydro-2H-1-benzopyran-2-one | 0.50 | 0.50 | 0.50 | 0.50 |
| | | (Octahydrocoumarin) | | | | |
| (D1) | ARISTOFLEX HMB | (Acryloyl dimethyl taurine | 0.50 | | | |
| | | ammonium/beheneth-25 | | | | |
| | | methacrylate) cross polymer | | | | |
| (D2) | PEMULEN TR-1 | (Acrylate/alkyl acrylate (C10 to | | 0.50 | | |
| | | C30)) cross polymer | | | | |
| (D3) | PEMULEN TR-2 | (Acrylate/alkyl acrylate (C10 to | | | 0.50 | |
| | | C30)) cross polymer | | | | |
| (C) | Ion exchanged water | | 69.00 | 69.00 | 69.00 | 69.50 |
| Total | | | 100.00 | 100.00 | 100.00 | 100.00 |
| Mass ratio (A)/(B) | | | 60 | 60 | 60 | 60 |
| Mass ratio (A)/(C) | | | 0.43 | 0.43 | 0.43 | 0.43 |
| Evaluation | Repellent sustaining effect (Repellent rate after applying for 3 | | 94 | 90 | 89 | 94 |
| results | hours (%)) | | | | | |
| | Odor intensity | Score | 2.7 | 2.7 | 2.7 | 2.7 |
| | | Judgement | B | B | B | B |
| | Long-term storage stability | Judgement | A | A | A | A |

From Table 2 and Tables 4 to 7, it is noted that the compositions of the present invention each containing predetermined amounts of the components (A) and (B) (Examples 1 to 39) are high in the repellent rate after a lapse of applying for 3 hours so that the excellent sustainability of repellent effect is exhibited, and are low in the odor intensity so that the odor derived from the component (B) that is a fragrance having a repellent effect is suppressed.

### INDUSTRIAL APPLICABILITY

In accordance with the present invention, it is possible to provide a pest repellent composition which is excellent in the pest repellent sustaining effect against pests, particularly flying pests, is safe, is suppressed in the strong odor derived from a fragrance having a repellent effect, and is suited for application to the skin, a pest stay inhibition composition, a method for repelling pests, and a method for inhibiting pest stay.

What is claimed is:

1. A pest repellent composition comprising the following components (A), (B) and (D:
(A) 13% by mass or more and 99.95% by mass or less of at least one non-volatile liquid oily component selected from the group consisting of a silicone oil, an ester oil, an ether oil, a hydrocarbon oil, an aliphatic alcohol, and a polyhydric alcohol, the non-volatile liquid oily component having a surface tension at 25° C. of 40 mN/m or less and a viscosity at 23° C. as measured with a B-type rotational viscometer of 400 mPa·s or less;
(B) 0.05% by mass or more and 3.5% by mass or less of at least one fragrance selected from the group consisting of the following (B1) to (B9):
(B1) at least one lactone selected from the group consisting of octahydro-2H-1-benzopyran-2-one, gamma decalactone, delta decalactone, delta nonalactone, and gamma undecalactone,
(B2) at least one ketone selected from the group consisting of 9-ethylidene-3-oxatricyclo[6.2.1.02,7]undecan-4-one and octahydro-7-methyl-1,4-methanonaphthalene-6(2H)-one,
(B3) at least one aldehyde selected from the group consisting of 7-hydroxy-3,7-dimethyloctanal and octahydro-5-methoxy-4,7-methano-1H-indene-2-carboxyaldehyde,
(B4) at least one aromatic alcohol selected from the group consisting of phenylethyl methyl ethyl carbinol, cinnamic alcohol, and eugenol,
(B5) 2-(4-methyl-2-thiazolyl) ethanol,
(B6) ethyl-2-phenyl acetate,
(B7) (3-pentyloxan-4-yl) acetate,
(B8) phenylethyl dimethyl carbinyl acetate, and
(B9) methyl anthranilate; and
(D) a thickener.

2. A pest stay inhibition composition comprising the following components (A), (B) and (D):
(A) 13% by mass or more and 99.95% by mass or less of at least one non-volatile liquid oily component selected from the group consisting of a silicone oil, an ester oil, an ether oil, a hydrocarbon oil, an aliphatic alcohol, and a polyhydric alcohol, the non-volatile liquid oily component having a surface tension at 25° C. of 40 mN/m or less and a viscosity at 23° C. as measured with a B-type rotational viscometer of 400 mPa·s or less;
(B) 0.05% by mass or more and 3.5% by mass or less of at least one fragrance selected from the group consisting of the following (B1) to (B9):
(B1) at least one lactone selected from the group consisting of octahydro-2H-1-benzopyran-2-one, gamma decalactone, delta decalactone, delta nonalactone, and gamma undecalactone,
(B2) at least one ketone selected from the group consisting of 9-ethylidene-3-oxatricyclo[6.2.1.02,7]undecan-4-one and octahydro-7-methyl-1,4-methanonaphthalene-6(2H)-one,
(B3) at least one aldehyde selected from the group consisting of 7-hydroxy-3,7-dimethyloctanal and octahydro-5-methoxy-4,7-methano-1H-indene-2-carboxyaldehyde,
(B4) at least one aromatic alcohol selected from the group consisting of phenylethyl methyl ethyl carbinol, cinnamic alcohol, and eugenol,
(B5) 2-(4-methyl-2-thiazolyl) ethanol,
(B6) ethyl-2-phenyl acetate,
(B7) (3-pentyloxan-4-yl) acetate,
(B8) phenylethyl dimethyl carbinyl acetate, and
(B9) methyl anthranilate; and
(D) a thickener.

3. The composition according to claim 1, wherein the component (A) is at least one selected from the group consisting of a silicone oil, an ester oil, and a hydrocarbon oil.

4. The composition according to claim 1, wherein the content of the component (A) is 13% by mass or more and 75% by mass or less.

5. A method for repelling pests, comprising applying the composition according to claim 1 onto the skin surface of a human.

6. A method for inhibiting pest stay, comprising attaching the composition according to claim 2 onto limbs of a pest to prevent the pest from staying on the skin of a human.

7. The composition according to claim 1, wherein the surface tension at 25° C. of the component (A) is 15 mN/m or more.

8. The composition according to claim 1, wherein the viscosity at 23° C. of the component (A) as measured with the B-type rotational viscometer is 1 mPa·s or more.

9. The composition according to claim 1, wherein the mass ratio [(A)/(B)] of the component (A) to the component (B) is 10 or more and 400 or less.

10. The composition according to claim 1, wherein the content of other pest repellent than the component (A) and the component (B) is 15% by mass or less.

11. The composition according to claim 1, wherein the composition comprises water as component (C).

12. The composition according to claim 11, wherein the content of the component (C) in the composition is 5% by mass or more and 86.95% by mass or less.

13. The composition according to claim 11, wherein the mass ratio [(A)/(C)] of the component (A) to the component (C) is 0.05 or more and 10 or less.

14. The composition according to claim 11, wherein the composition is a water-in-oil type composition.

15. The composition according to claim 1, wherein the content of the component (D) in the composition is 0.01% by mass or more and 5% by mass or less.

16. The composition according to claim 1, wherein the component (D) comprises a water-soluble cationic polymer, anionic polymer, nonionic polymer, or, an amphoteric polymer or dipolar polymer.
